(19) United States
(12) Patent Application Publication
(10) Pub. No.: US 2016/0196292 A1
(43) Pub. Date: Jul. 7, 2016

(54) DATA RELEVANCE CALCULATION PROGRAM, DEVICE, AND METHOD

(71) Applicant: FUJITSU LIMITED, Kawasaki-shi (JP)

(72) Inventors: Satoshi MUNAKATA, Kawasaki (JP); Yuji Mizobuchi, Kawasaki (JP); Kuniharu Takayama, Tama (JP)

(73) Assignee: FUJITSU LIMITED, Kawasaki (JP)

(21) Appl. No.: 14/971,312

(22) Filed: Dec. 16, 2015

(30) Foreign Application Priority Data
Jan. 5, 2015 (JP) 2015-000491

(51) Int. Cl. G06F 17/30

(52) U.S. Cl. CPC G06F 17/30321; G06F 17/30867; G06F 17/30598

(57) ABSTRACT

Data relevance calculation program for; extracting topics from a group of individual data items and a group of target data items, each item including an index part and a content part, and at least a part of the target data items is related to any of the individual data items, based on words included in the individual data items and the target data items; setting an attribute of each topic based on a degree at which the topic is characterized by words included in the index part or included in the content part; and calculating relevance between any of the individual data items and each of the target data items based on the strength of a relationship between a topic included in an individual data item and a topic included in a target data item related to the individual data item and on the attribute of each topic.

### CROSS-REFERENCE TO RELATED APPLICATION

This application is based upon and claims the benefit of priority of the prior Japanese Patent Application No. 2015-000491, filed on Jan. 5, 2015, the entire contents of which are incorporated herein by reference.

### FIELD

The embodiments discussed herein are related to a data relevance calculation program, a data relevance calculation device, and a data relevance calculation method.

### BACKGROUND

There is a case in which another document related to a specific document is searched for from a group of a plurality of documents in related art. As a method of specifying related document, relevance between documents is estimated based on topic models. For example, the following technique has been proposed.

Specifically, first as preprocessing, topics are extracted from a group of documents. The topics are extracted to determine occurrence probability of words in the documents. On the assumption that a plurality of topics are present together in each document, usage of words in a document is modeled based on the probability in such a manner that a word A occurs at a rate of 21% and a word B occurs at a rate of 11% for a specific topic, for example. Then, topic models are constructed by obtaining topic mixing rates in each document based on the probability models of the usage of words and further obtaining the strength of relationships between topics based on the relevance between the documents.

Then, a certain number of topics with strong relationships with topics included in a specific document are specified by using the topic models when documents related to the specific document are specified. In addition, another document in which the certain number of topics frequently occur is specified as the document related to the specific document.

David M. Blei, Andrew Y. Ng, and Michael I. Jordan, “Latent Dirichlet Allocation”, the Journal of Machine Learning Research 3, 2003, pp. 993-1022 and Yan Liu, Alexandru Niculescu-Mizil, and Wojciech Gryc, “Topic-link LDA: Joint Models of Topic and Author Community”, proceedings of the 26th annual international conference on machine learning, ACM, 2009 are examples of the related art.

If common index words are present in each document included in the group of documents in the case of employing the method of using the topic models as described above, topics derived from the index words are commonly included in each document. Therefore, it may be estimated that all the documents have relevance to each other.

It is considered that fixed index words are excluded from each document before extracting topics from the group of documents in a case of a research paper, for example, in which fixed index words such as “Introduction”, “Problems”, and “Related studies” are included. However, even in a document that does not include fixed index words, index words for organizing the document, such as “Decision”, “Date of meeting”, and “Deadline” are used in some cases. Such index words have no commonality among the documents included in the group of documents, and it is difficult to exclude such index words in advance.

In addition, topics that are derived from index words are considered to work for facilitating classification of types of documents (purposes of documents, methods conveyed by documents, and the like) and serve as useful information for estimating relevance between the documents in some cases. Therefore, there is a problem that useful information for appropriately estimating relevance between documents may be missing even in a case in which index words with no commonality is able to be excluded by some method.

According to an aspect of the embodiment, it is desirable to appropriately calculate relevance between data including index words with no commonality.

### SUMMARY

According to an aspect of the invention, a non-transitory and computer-readable storage medium that stores a data relevance calculation program for causing a computer to execute processing includes: extracting a plurality of topics from a group of individual data items, each of which includes an index part and a content part, and a group of target data items, each of which includes an index part and a content part, and at least a part of which is related to any of the individual data items, based on words that are included in the group of the individual data items and the group of the target data items; setting an attribute of each of the topics based on at least one of a degree at which each of the extracted topics is characterized by words that are included in the index part and a degree at which each of the extracted topics is characterized by words that are included in the content part; and calculating relevance between any of the individual data items that are included in the group of the individual data items and each of the target data items that are included in the group of the target data items based on the strength of a relationship between a topic that is included in an individual data item and a topic that is included in a target data item related to the individual data item and on the attribute of each of the topics.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a ticket management system;

FIG. 2 is a conceptual diagram illustrating an example of tickets and files;

FIG. 3 is an explanatory diagram of an application of a topic model to the ticket management system;

FIG. 4 is a functional block diagram illustrating an outline configuration of a data relevance calculation device according to an embodiment;

FIG. 5 is a conceptual diagram illustrating an example of tickets and files;

FIG. 6 is a diagram illustrating an example of a ticket and file database (DB);

FIG. 7 is a diagram illustrating an example of words extracted from each document;

FIG. 8 is a diagram illustrating an example of a topic model DB being constructed;

FIG. 9 is a diagram illustrating an example of a template DB;

FIG. 10 is an explanatory diagram of setting of types of topics;

FIG. 11 is a diagram illustrating an example of the topic model DB being constructed;

FIG. 12 is an explanatory diagram of an optimal value of a coefficient c for adjusting weights of relationships;

FIG. 13 is an explanatory diagram of relationships between topics derived from index words and topics derived from content words;

FIG. 14 is a conceptual diagram illustrating a state in which weights of relationships are adjusted;

FIG. 15 is an explanatory diagram of the adjustment of the weights of relationships;

FIG. 16 is an explanatory diagram of registration of topic names;

FIG. 17 is a diagram illustrating relationships between tables;

FIG. 18 is a diagram illustrating an example of an operation screen on which a ticket to be read is being displayed;

FIG. 19 is a diagram illustrating an example of the operation screen on which a recommended file is being displayed;

FIG. 20 is a block diagram illustrating an outline configuration of a computer that functions as the data relevance calculation device according to the embodiment;

FIG. 21 is a flowchart illustrating an example of preprocessing;

FIG. 22 is a diagram illustrating an example of a topic table;

FIG. 23 is a diagram illustrating an example of a ticket-topic table;

FIG. 24 is a diagram illustrating an example of a file-topic table;

FIG. 25 is a diagram illustrating an example of a topic-topic table;

FIG. 26 is a flowchart illustrating an example of specification processing;

FIG. 27 is a diagram illustrating an example of a result of calculating relevance according to the embodiment;

FIG. 28 is a diagram illustrating an example of a result of calculating relevance in a case in which the weights of relationships are not adjusted based on the types of the topics;

FIG. 29 is a conceptual diagram illustrating an example of tickets and files;

FIG. 30 is a diagram illustrating an example of the topic model DB in a case in which the weights of relationships are not adjusted based on the types of the topics;

FIG. 31 is an explanatory diagram of calculation of relevance in a case in which the weights of relationships are not adjusted based on the types of the topics;

FIG. 32 is an explanatory diagram of setting of the types of the topics;

FIG. 33 is an explanatory diagram of adjustment of the weights of relationships between the topics; and

FIG. 34 is an explanatory diagram of calculation of relevance according to the embodiment.

### DESCRIPTION OF EMBODIMENTS

Hereinafter, an exemplary embodiment of the technique disclosed herein will be described in detail with reference to drawings. In this embodiment, a case in which the technique disclosed herein is applied to a ticket management system that manages tasks by using tickets will be described.

Before describing the details of the embodiment, a description will be given of the ticket management system first.

A “ticket” in the ticket management system is a concept corresponding to a written task instruction and is a unit in which one task is managed. For example, the ticket is document data in which content of the task, priority, a person in charge, a date, and progress, for example, are described in a natural language.

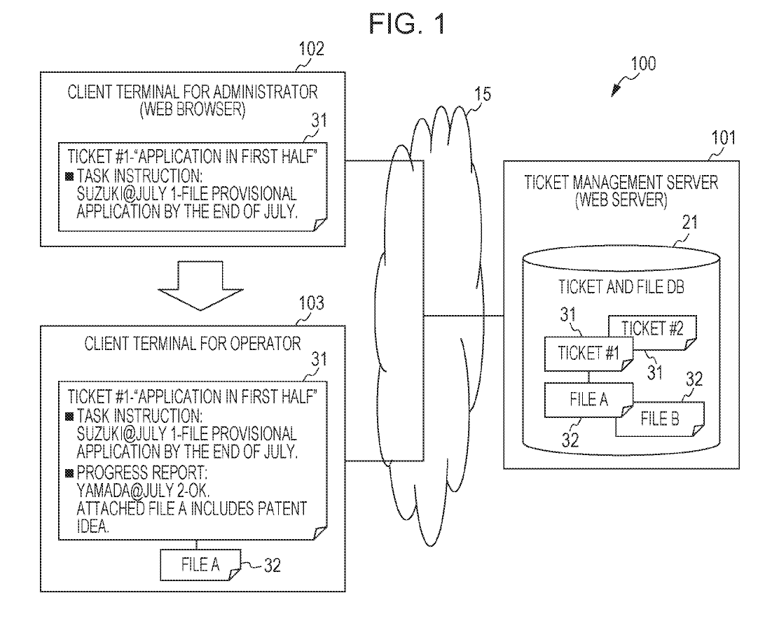

As illustrated in FIG. 1, a ticket management system 100 includes a ticket management server 101 that functions as a web server, a client terminal 102 for an administrator on which a web browser is installed, and a client terminal 103 for an operator. The ticket management server 101 is connected to each of the client terminals 102 and 103 via a network 15. Although one client terminal 102 and one client terminal 103 are illustrated in FIG. 1, a plurality of client terminals 102 and a plurality of client terminals 103 may be included. The ticket management system 100 provides, as a web application, management functions such as issue, reference, search, and update of tickets.

As illustrated in FIG. 1, an administrator issues a new ticket 31 from the client terminal 102 for the administrator, assigns an operator in charge, and stores the ticket 31 in a ticket and file database (DB) 21 in the ticket management server 101. The operator in charge accesses the ticket management server 101 from the client terminal 103 of the operator themselves and obtains the corresponding ticket 31. Then, the operator in charge updates content of record in the ticket 31 in accordance with a progress of the task. In doing so, management of the task and communication between the administrator and the operator are realized. In FIG. 1, month and date follow the name and the symbol @. The hour, minute, and second may also be displayed together if desired.

Since content of a task instruction and a progress report of the task are recorded in the ticket 31 as described above, the content of record in the ticket 31 is desired to be read when the task is started or the progress report is checked.

For instructing a complicated task or reporting a progress by using a created material as an achievement, for example, a data file in which such content is described (hereinafter, simply referred to as a “file 32”) is attached to the ticket 31 in some cases. The ticket 31 is an example of individual data of the technique disclosed herein, and the file 32 is an example of target data of the technique disclosed herein. For example, there is a case in which the file 32 of an explanatory material to be used in a meeting is attached to the ticket 31 for instructing to hold the meeting. In such a case, the content of record in the attached file 32 is also desired to be read in order to precisely read the content of record in the ticket 31 for instructing to hold the meeting.

In relation to a specific ticket 31, other related tickets 31 including the ticket 31 for a preceding or following task and the ticket 31 for a task to be accomplished at the same time are also referred in many cases. For example, there is a case in which in relation to a ticket 31 for instructing to hold a meeting, another ticket 31 for instructing to create an explanatory material to be used in the meeting is also referred. The operator determines which tickets 31 are to be referred in relation to the specific ticket 31.

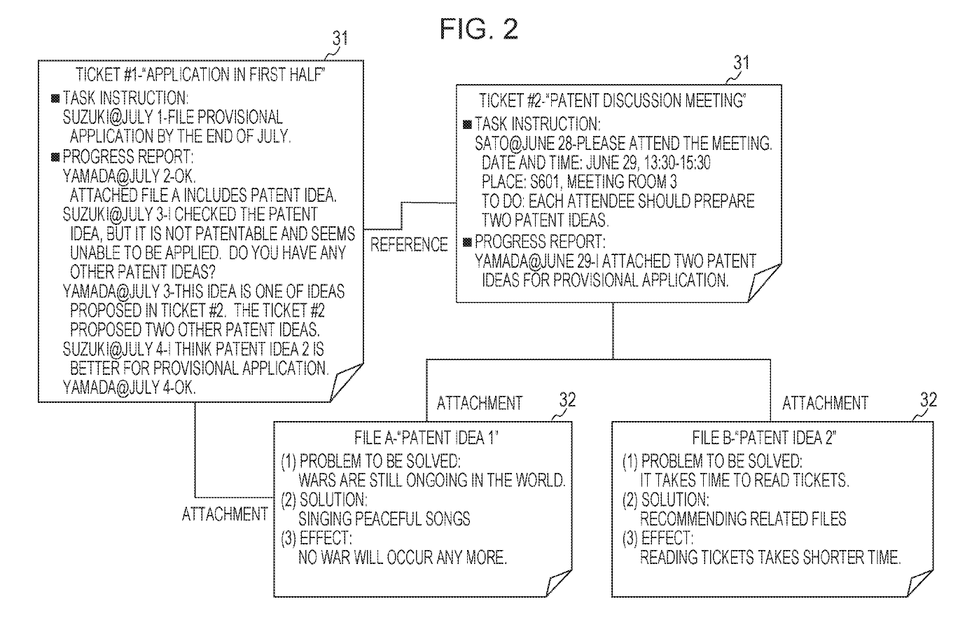

As described above, there is a case in which the tickets 31 have relevance to each other or the ticket 31 and the file 32 have relevance to each other. FIG. 2 conceptually illustrates an example of relevance between the tickets 31 and between the ticket 31 and the file 32. In the following description, a ticket 31 whose ticket ID as an identifier of the ticket 31 is “x” will be described as a “ticket #x”. In addition, a file 32 whose file ID as an identifier of the file 32 is “x” will be described as a “file x”.

In the example illustrated in FIG. 2, a file A is attached to a ticket #1. That is, the ticket #1 and the file A have relevance to each other. In addition, a ticket #2 is referred in relation to the ticket #1. That is, the ticket #1 and the ticket #2 have relevance to each other. In addition, the file A and a file B are attached to the ticket #2. That is, the ticket #2 and each of the file A and the file B have relevance to each other.

The ticket management system 100 can search files 32 and other tickets 31 that help reading of the ticket 31, by such a function of tracking relevance between the tickets 31 and between the ticket 31 and the file 32. In the example illustrated in FIG. 2, the ticket #2 that is referred in relation to the ticket #1 is tracked, the file B that is attached to the ticket #2 is then tracked, and the file B can be viewed, for example, for interpreting the ticket #1.

However, there is also a case in which other tickets 31 and files 32 that are important for reading the specific ticket 31 are not associated with the specific ticket 31. This is because it is difficult to mechanically determine to which ticket 31 a specific file 32 is to be attached. Therefore, the operator determines a ticket 31 (the ticket #1, for example) based on intuition from among a plurality of tickets 31 and associates a file 32 (only the file A, for example) with only the ticket 31 in many cases. Since different operators deal with the respective tickets 31 for associating the tickets 31, it is difficult to understand content of other tickets 31 and to perform association without any omission.

If association of related tickets 31 and association of related tickets 31 and files 32 include some omissions, it is difficult to be aware of the presence of the file 32, which originally has relevance, in the task of reading the ticket 31 in some cases. In such cases, it may take time to perform the task of reading the ticket 31 since the related file 32 is not read.

The embodiment is intended to specify a group of a relatively small number of files (a number of files that a person can grasp at a first sight), which includes files 32 related to a specific ticket 31 at a high rate, from among multiple files 32 that have already been registered in the ticket management system. Even in the case in which the association of the related tickets 31 and the association of the related tickets 31 and the files 32 include some omissions, it is possible to improve efficiency of the task of reading the specific ticket 31 by specifying related files 32.

Here, a case will be considered in which the technique of estimating relevance between the tickets 31 and files 32 by using a topic model is applied to search for the files 32 that are registered in the ticket management system 100.

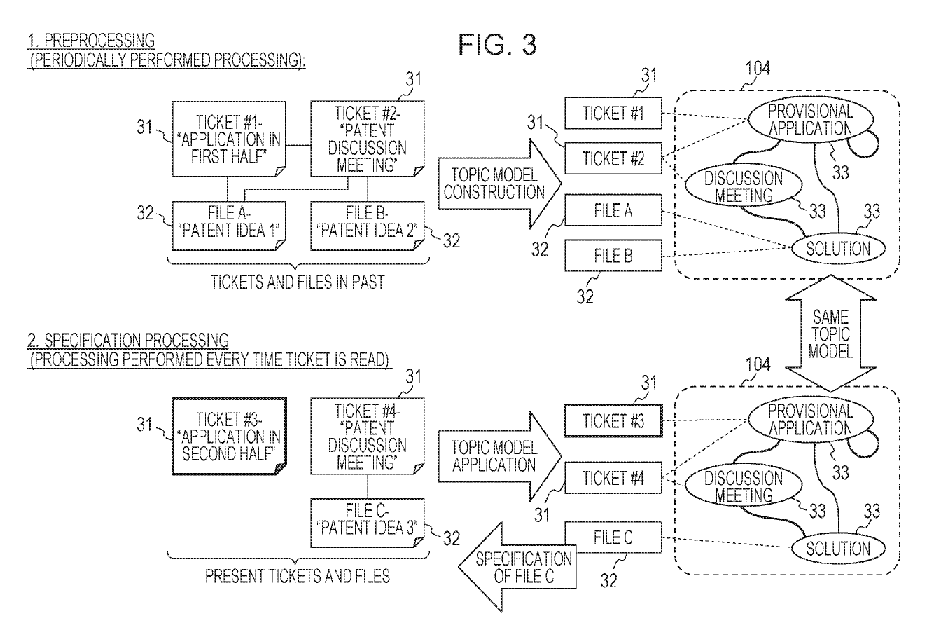

For example, a topic model 104 is constructed from a group of the tickets 31 and a group of the files 32 that are registered in the ticket management system 100 at a specific timing, as preprocessing as illustrated in the upper section of FIG. 3. Here, the ticket #1, the ticket #2, the file A, and the file B are associated as illustrated in FIG. 2. In addition, the ticket #1 and the ticket #2 include a topic of “Provisional application”, the ticket #2 include a topic of “Discussion meeting”, and the file A and the file B include a topic of “Solution”. In addition, relationships between the respective topics are obtained based on how the ticket #1, the ticket #2, the file A, and the file B are related to each other. In FIG. 3, topic names of topics 33 included in the topic model 104 are represented in ovals, and the strength of the relationships between the topics 33 is represented by thicknesses of lines that connect the topics 33.

The topic model 104 is applied to the group of the tickets 31 and the group of the files 32 that are registered in the ticket management system 100 at a timing when a specific ticket 31 is read, and files 32 that are related to the specific ticket 31 are specified. The example in the lower section of FIG. 3 corresponds to a state in which a ticket #4 and a file C are registered in the ticket management system 100 when another ticket #3 that is not associated with the aforementioned tickets 31 and the files 32 is read. The ticket #3 includes the topic of “Provisional application”, the ticket #4 includes the topic of “Discussion meeting”, and the file C includes the topic of “Solution”. The relationships between these topics 33 are applied to the topic model 104 that has been constructed as described above. Since the topics 33 included in the ticket #3 have relationships with the topics 33 included in the file C, it is possible to specify the file C as a file 32 that is related to the ticket #3.

Here, a description will be given of a problem that occurs when the topic model 104 is constructed from the tickets 31 and the files 32.

In a case in which target documents are research papers, for example, index words are limited to a small number of words that commonly and frequently occur in the respective research papers. Therefore, the index words do not contribute to classification of types of the documents, and further, strongly tend to inhibit estimation of relevance of the documents. Specifically, “topics in which the common index words can occur” occur at high rates in all the research papers, and can bring about the occurrence of relationships with other topics that include the “topics in which the common index words can occur” themselves at high rates. As a result, it is estimated that a specific research paper has relevance with all other research papers.

Appropriate methods of excluding index words and stop words from research papers are experimentally known. For example, it is possible to exclude, as stop words, functional words such as “that”, “however”, and “because” that are known to commonly and frequently occur not only in research papers but also in all kinds of documents. In addition, it is possible to uniformly exclude index words such as “Introduction”, “Related studies”, and “Conclusion” that are known to commonly and frequently occur in various research papers.

However, the tickets 31 and the files 32 that are handled in the ticket management system 100 are documents that report various business operations, requests for tasks, progress reports, and achievements as text. The operator who creates the tickets 31 and the files 32 tends to voluntarily consider and describe “index words” in accordance with such various purposes if desired. It is more difficult to exclude the index words described in such a manner, which have no commonality between the tickets 31 and the files 32, as compared with a case of research papers. This is because there is a possibility that words that frequently occur by chance only in the tickets 31 and the files 32 that are registered at present are determined to be index words, or a possibility that words that are originally index words but do not frequently occur by chance are determined not to be index words.

In a case of constructing a topic model without excluding index words, the topic model include topics in which only index words can occur at high rates, topics in which only content words can occur at high rates, and topics in which both the index words and the content words can occur at high rates. Here, the “content words” are words that are included in content parts other than the index words in the documents. Relationships between the topics in which only the index words can occur at high rates and the topics in which only the content words can occur at high rates work so as to able to have relationship with many other tickets 31 and files 32 regardless of types of the tickets 31 and the files 32. The same is true for the relationships between the topics in which both the index words and the content words can occur at high rates.

In contrast, there is an aspect that “index words” differ depending on types of documents (purposes delivered by documents, delivering methods of documents, and the like). Therefore, the construction of the topic model without the exclusion of the “index words” allows the relationships between the topics in which only the index words can occur at high rates to help classification of combinations of document types (records of meeting, meeting materials, research papers, and the like). That is, there is an advantage that it is possible to more appropriately estimate relevance of documents by constructing the topic model without excluding the “index words”.

Therefore, a topic model designed such that relationships between topics do not inhibit estimation of relevance of documents is constructed without excluding index words in order to achieve the advantage in this embodiment.

Hereinafter, a detailed description will be given of the embodiment with reference to drawings. The same reference numerals are given to parts, which are common to those in the embodiment, in the aforementioned ticket management system 100, and detailed descriptions thereof will be omitted.

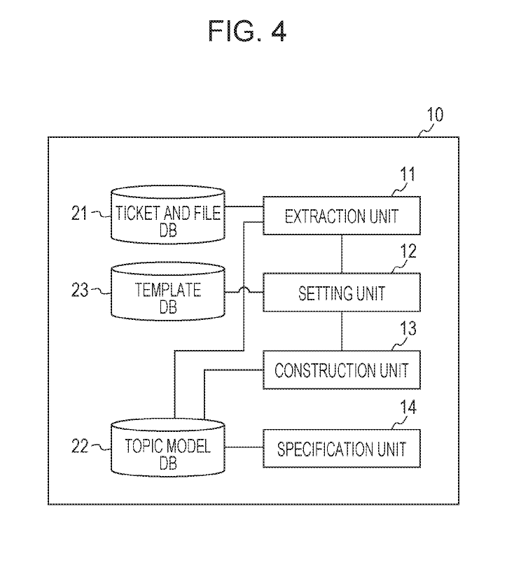

As illustrated in FIG. 4, a data relevance calculation device 10 according to the embodiment includes an extraction unit 11, a setting unit 12, a construction unit 13, and a specification unit 14. The construction unit 13 and the specification unit 14 are an example of the calculation unit of the technique disclosed herein. In addition, the data relevance calculation device 10 includes a ticket and file DB 21, a topic model DB 22, and a template DB 23.

The ticket and file DB 21 stores a group of the tickets 31 and a group of the files 32 that are registered in the ticket management system 100, information on relevance of the tickets 31, and information on relevance between the tickets 31 and the files 32.

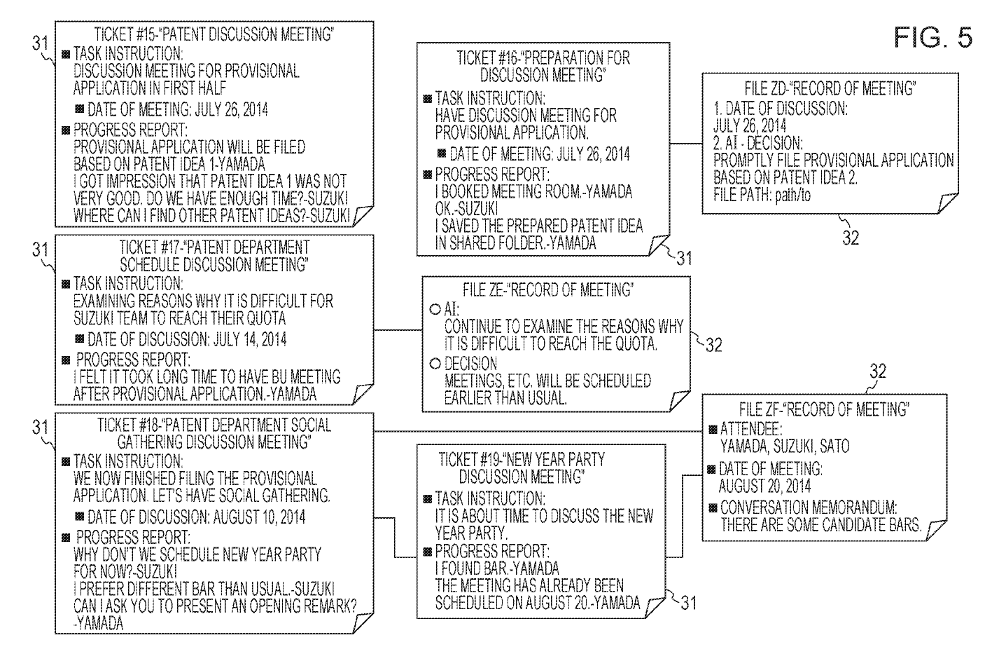

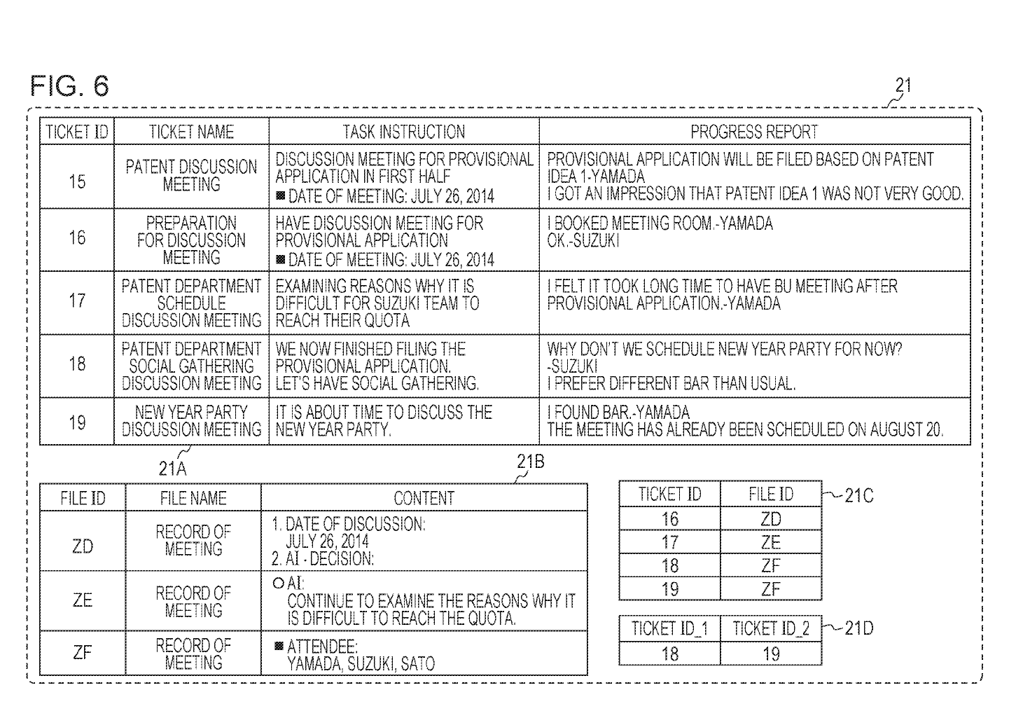

FIG. 5 conceptually illustrates an example of the tickets 31 and the files 32 that are stored in the ticket and file DB 21 and information on relevance thereof. In the example illustrated in FIG. 5, the tickets 31 are assumed to include items of “task instructions” and “progress reports”. These items are different from phrases that are input by a user, such as “index words” in the embodiment, and are defined as a part of structures of the tickets as illustrated in a ticket table 21A in FIG. 6. Therefore, these items are common to all the tickets 31.

FIG. 6 illustrates an example of various tables that are included in the ticket and file DB 21. As illustrated in FIG. 6, the ticket and file DB 21 includes the ticket table 21A, a file table 21B, a ticket-file table 21C, and a ticket-ticket table 21D.

Each record (each row) of the ticket table 21A corresponds to one ticket 31 and includes items of “Ticket ID”, “Ticket name”, “Task instruction”, and “Progress report”. “Ticket ID” is an identifier of the ticket 31 corresponding to the record. “Ticket name” is a character sequence that represents a name of a ticket that is identified by a corresponding ticket ID. In the example illustrated in FIG. 5, the ticket name is represented in a quotation mark connected to representation of “TICKET#x (x is a ticket ID)” with “- (hyphen)”. “Task instruction” and “Progress report” are text data that are described in the items of “Task instruction” and “Progress report” of the ticket 31 identified by a corresponding ticket ID.

Each record (each row) of the file table 21B corresponds to one file 32 and includes items of “File ID”, “File name”, and “Content”. “File ID” is an identifier of the file 32 that corresponds to the record. “File name” is a character sequence that represents a name of the file that is identified by a corresponding file ID. In the example illustrated in FIG. 5, the file name is represented in a quotation mark connected to representation of “FILE x (x is a file ID) with “- (hyphen)”. “Content” is text data that is described in the file 32 identified by the file ID.

Each record (each row) of the ticket-file table 21C corresponds to one information item on relevance between the ticket 31 and the file 32 and includes items of “Ticket ID” and “File ID”. “Ticket ID” is a ticket ID of the related ticket 31, and “File ID” is a file ID of the related file. In FIG. 5, the tickets 31 and the files 32 with relevance to each other are illustrated with connecting lines.

Each record (each row) of the ticket-ticket table 21D corresponds to one information item on relevance between the tickets 31 and includes items of “Ticket ID_1” and “Ticket ID_2”. “Ticket ID_1” is a ticket ID of one of the related tickets 31, and “Ticket ID_2” is a ticket ID of the other ticket 31. In FIG. 5, the tickets 31 with relevance to each other are illustrated with a connecting line.

The extraction unit 11 obtains a group of topics and a topic mixing rate in each of the tickets 31 and the files 32 from the group of the tickets and the group of the files that are stored in the ticket and file DB 21. As a method of extracting the topics, a method that is known in related art can be used. In this embodiment, a description will be given of a case in which a Latent Dirichlet Allocation (LDA) algorithm, as one example. In the following description, the group of the tickets and the group of the files will be collectively referred to as a “group of documents D”, and each of the tickets 31 and the files 32 will also be referred to as a “document”.

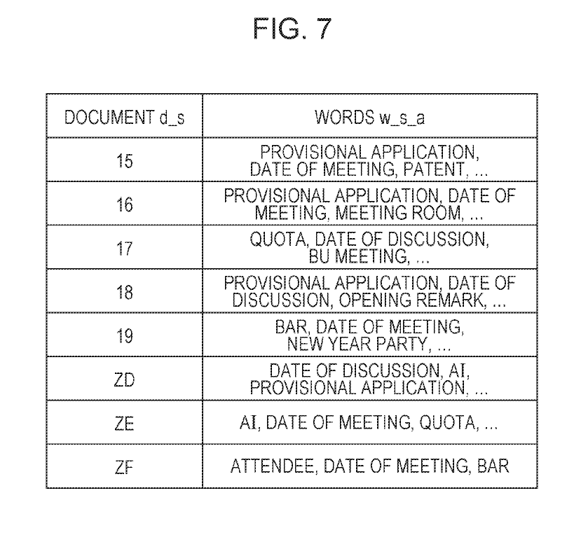

The extraction unit 11 obtains a document d_s (s=1, 2, . . . , S; S is the total number of documents; d_sεD) that is included in the group of documents D that are stored in the ticket and file DB 21. The extraction unit 11 extracts words w_s_a (a=1, 2, . . . , A; A is the total number of words that are extracted from the document d_s; w_s_aεd_s) from each document d_s by morphological analysis in order to covert the document d_s into a format in which the document d_s can be input to the LDA algorithm. FIG. 7 illustrates an example of the words w_s_a that are extracted from each document d_s. In FIG. 7, each document d_s is represented by a ticket ID of the ticket 31 or a file ID of the file 32 corresponding to the document d_s.

The extraction unit 11 sets, as parameters of the LDA algorithm, the number tn of topics (tn>0) and the number fn of top feature words (fn>0) that represent features of each topic. The extraction unit 11 obtains a group of topics TP (|TP|=tn, tp−tεTP) based on the LDA algorithm by using the words w_s_a extracted from the respective documents d_s and the set parameters tn and fn. Here,
{(ft_t_1,fp_t_1), . . . }εtp_t,
0<|tp_t|≦fn, 0.00<fp_t_u≦1.00.

In addition, ft_t_u represents each feature word of a topic tp_t, and fp_t_u is a probability at which the feature word ft_t_u occurs from the topic tp_t (hereinafter, referred to as an “occurrence probability”).

In addition, the extraction unit 11 obtains a topic mixing rate MP (mp_vεMP, |MP|=|D|) in each document d_s based on the LDA algorithm. The topic mixing rate is a value that represents a rate at which each topic is mixed in one document based on probability at which each topic occurs in each document d_s. Here,
{(tp_v_1,tpmp_v_1), . . . }εmp_v,
0≦|mp_v|tn, tp_v_wεTP,
0.00<tpmp_v_w≦1.00.

In addition, tp_v_w represents each topic included in the document d_v, and tpmp_v_w represents a mixing rate of the topic tp_v_w in the document d_v. The extraction unit 11 stores the extracted group of topics TP and the mixing rate MP of the topic in the topic model DB 22.

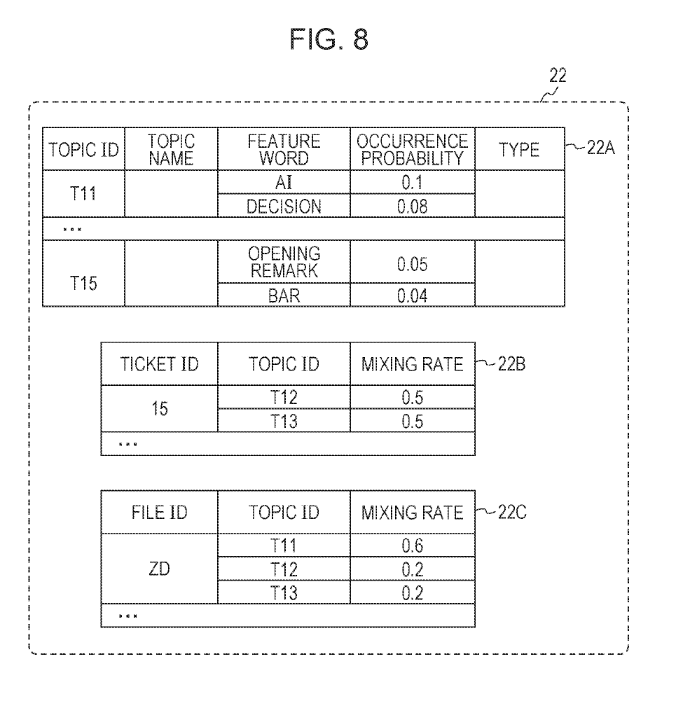

As illustrated in FIG. 8, the topic model DB 22 includes a topic table 22A, a ticket-topic table 22B, and a file-topic table 22C. The topic model DB 22 further includes a topic-topic table 22D, which will be described later.

The topic table 22A includes items of “Topic ID”, “Topic name”, “Feature word”, “Occurrence probability”, and “Type” for each topic. “Topic ID” is an identifier of each topic that is extracted from the group of documents D. In addition, tn topics are extracted by setting the aforementioned parameter tn. “Topic name” is a character sequence that represents a name of a topic identified by the topic ID and is manually registered as will be described later. “Feature word” is a word extracted as a word that characterizes a topic when the topic identified by a corresponding topic ID is extracted, that is, a character sequence that represents a word that can occur in the topic. “Occurrence probability” is a numerical value that represents an occurrence probability of each feature word in the topic identified by the corresponding topic ID. By setting the aforementioned parameter fn, fn feature words with top occurrence probabilities are extracted from each topic.

The ticket-topic table 22B includes items of “Ticket ID”, “Topic ID”, and “Mixing rate” for each ticket 31. “Topic ID” is a topic ID of a topic that is included in a ticket 31 identified by a corresponding ticket ID. “Mixing rate” is a numerical value that represents a mixing rate of each topic that is included in the ticket 31 identified by the corresponding ticket ID.

The file-topic table 22C includes items of “File ID”, “Topic ID”, and “Mixing rate” for each file 32. “Topic ID” is a topic ID of a topic that is included in a file 32 identified by a corresponding file ID. “Mixing rate” is a numerical value that represents a mixing rate of each topic that is included in the file 32 identified by the corresponding file ID.

The setting unit 12 sets a type (attribute) that represents which of a topic derived from index words and a topic derived from content words each topic is, based on which of index words and content words the feature words of each topic extracted by the extraction unit 11 are. Specifically, the setting unit 12 sets a type of a topic, which includes feature words extracted from an index part of each document at a higher rate, to “Index” that represents that the topic is derived from index words. In addition, the setting unit 12 sets a type of a topic, which includes feature words extracted from a content part other than the index part in each document at a higher rate, to “Content”.

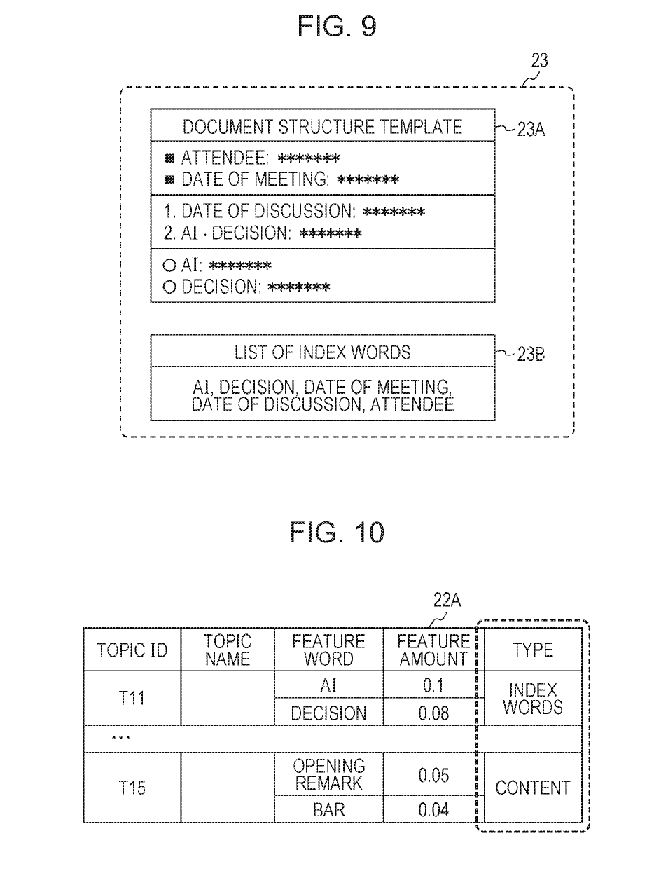

The index part and the content part in each document are specified by using a document structure template 23A that is stored in the template DB 23. FIG. 9 illustrates an example of the document structure template 23A. The document structure template 23A is a template for specifying an index part in a document based on a document structure such as itemization.

The setting unit 12 extracts words that are included in the index part specified by applying the document structure template 23A to each document and stores the words in an index word list 23B in the template DB 23 as illustrated in FIG. 9. The setting unit 12 determines that each feature word is an “index word” when the feature word that is included in each topic stored in the topic table 22A coincides with any of words that are stored in the index word list 23B, and determines that the feature word is a “content word” when the feature word does not coincide with any of the words that are stored in the index word list 23B.

Then, the setting unit 12 determines which of index words and content words each topic is derived from, based on a result of determining which of an “index word” and a “content word” each feature word in each topic corresponds to. If the number of feature words determined to be “index words” is larger than the number of feature words determined to be “content words”, for example, then it is possible to determine that the topic is “derived from the index words”. Alternatively, a determination may be made by using a sum Pa of occurrence probabilities of the feature words determined to be “index words” and a sum Pb of occurrence probabilities of the feature words determined to be “content words”. If Pa>Pb, or Pa>a threshold value (0.8, for example), for example, it is possible to determine that the topic is derived from index words. In addition, the embodiment is not limited to the case of discretely making a decision regarding which of index words and content words a topic is derived from. Values of Pa and Pb may be directly set as types of topics by regarding Pa as a degree at which each topic is derived from index words and regarding Pb as a degree at which each topic is derived from content words.

The setting unit 12 sets “Index” in the section of “Type in the topic table 22A for a topic that is determined to be derived from index words, and sets “Content” for a topic that is determined to be derived from content words as represented by the broken line in FIG. 10.

The construction unit 13 obtains a weight of a relationship that represents the strength of a relationship between topics based on information on relevance between documents and a type of each topic. The construction unit 13 obtains the weight of the relationship based on an idea that topics that are included in each of documents with relevance to each other have a relationship at a probability in accordance with mixing rates of the topics that are included in each of the documents. For example, the construction unit 13 obtains a weight of a relationship (Tₓ, T_{y}) between a topic Tₓ and a topic T_{y} by the following Equation (1).

Weight of relationship(Tₓ,T_{y})=(RT(Tₓ,T_{y})+RT(T_{y},Tₓ))/2 (1)

where RT(Tₓ, T_{y}) satisfies the following Equation (2).

$$RT ( {T}_{x} , {T}_{y} ) = {\sum }_{{o}_{y} , {T}_{y} ∈ {o}_{y} ∈ OBJECT} Mixing rate ( {o}_{y} , {T}_{y} ) {\sum }_{{o}_{x} , {T}_{x} ∈ {o}_{x} ∈ OBJECT} Mixing rate ( {o}_{x} , {T}_{x} ) \cdot Rel ( {o}_{y} , {o}_{x} ) \qquad ( 2 )$$

Here, OBJECT represents a group of objects that are tickets 31 and the files 32 stored in the ticket and file DB 21. Oₓ represents an object that includes the topic Tₓ, and O_{γ} represents an object that includes a topic T_{γ}. In addition, Rel(o_{y}, oₓ) is a function that returns “1” when the objects oₓ and o_{y} have relevance to each other and returns “0” when the objects oₓ and o_{y} have no relevance.

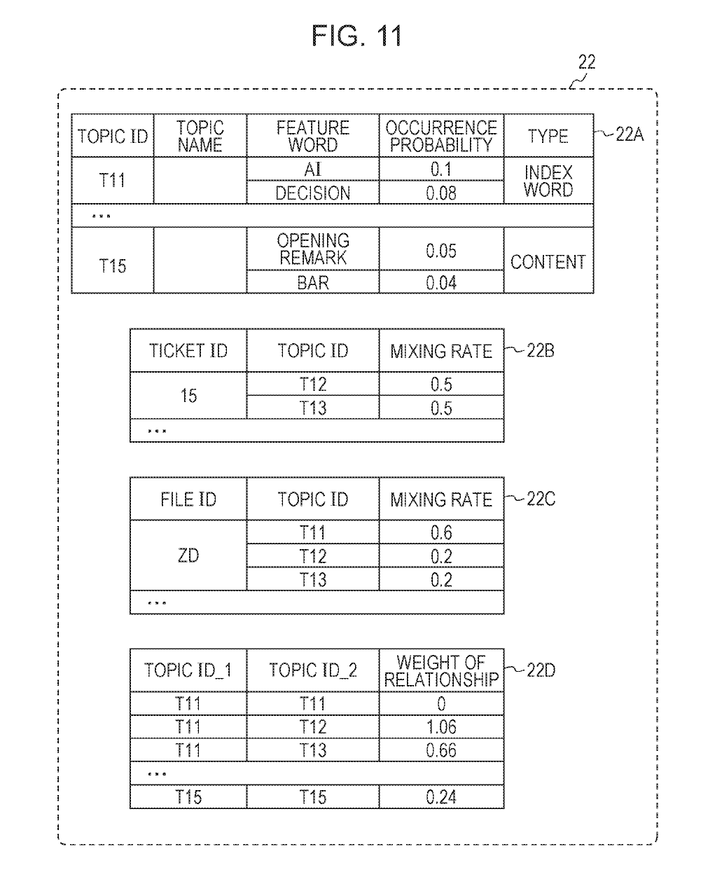

The construction unit 13 stores the weight of the relationship between the topics, which is obtained by the aforementioned Equation (1), in the topic-topic table 22D in the topic model DB 22 as illustrated in FIG. 11, for example. The topic-topic table 22D includes items of “Topic ID_1”, “Topic ID_2”, and “Weight of relationship” for each combination of topics. “Topic ID_1” is a topic ID of one of a combination of topics, and “Topic ID_2” is a topic ID of the other topic. “Weight of relationship” is a numerical value that represents a weight of a relationship obtained for the corresponding combination of the topics.

In addition, the construction unit 13 adjusts the value of “Weight of relationship” stored in the topic-topic table 22D based on types of the topics. Specifically, if one of a combination of topics is a different type from the other topic, the weight of the relationship is adjusted to the minimum. By such adjustment, an influence of the relationship between the topics of different types on estimation of relevance between documents is suppressed.

Specifically, the construction unit 13 obtains a type of each topic from the topic table 22A by using a topic ID as a key. Then, the construction unit 13 sets a weight of a relationship between a topic of an “index” type and a topic of a “content” type to be smaller than a weight of a relationship between topics of the “index” type or a weight of a relationship between topics of the “content” type. In doing so, the relationship “between topics derived from index words” works for facilitating classification of types of documents. In addition, the relationship “between a topic derived from index words and a topic derived from content words” makes it possible to suppress the disadvantage that it is estimated that all documents have relevance to each other.

More specifically, the construction unit 13 adjusts the weight of the relationship (Tₓ, T_{y}) between the topic Tₓ and the topic T_{y} by the following Equation (3) and obtains the adjusted weight of relationship (Tₓ, Tᵥ).

Adjusted weight of relationship(Tₓ,T_{y})=Weight of relationship(Tₓ,T_{y})·Same(Tₓ,T_{y}) (3)

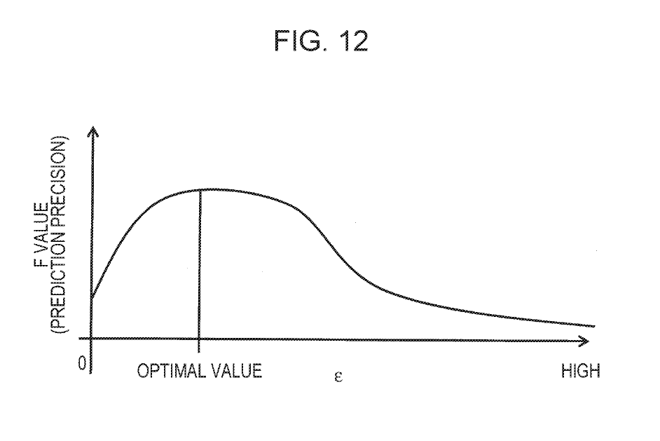

Here, Same (Tₓ, T_{y}) is a function that returns “1” when the type of the topic Tₓ is the same as the type of the topic T_{y}, and returns a coefficient “ε (ε<<1, ε=0.01, for example) when the type of the topic Tₓ is different from the type of the topic T_{y}. As ε, such a value that optimizes an F value representing precision of predicting the weight of the relationship when the magnitude of c varies with respect to a weight of a relationship that is obtained from machine learning with an instructor that uses correct answers may be obtained as illustrated in FIG. 12.

If Pa representing a degree of deriving from index words and Pb representing a degree of deriving from content words are set as a type of each topic, adjustment can be made by calculating the weight of the relationship×w. Here,

w=(Pa of one topic×Pa of the other topic)̂n+(Pb of one topic×Pb of the other topic)̂n.

w increases as the mutual topics are derived from the index words at a higher rate or as the mutual topics are derived from the content words at a higher rate. w increases as n increases when the mutual topics similarly derived from the index words or the content words.

Here, a description will be given of a reason why the adjustment of the 9 suppress the disadvantage that it is estimated that all documents have relevance to each other.

As described above, only one type of documents are present in a case in which target documents are a group of research papers. However, multiple types of documents are included in the group of the tickets and the group of the files. Due to characteristics of the ticket management system 100 that manages tasks, documents of different types tend to have relevance to each other as compared with documents of the same type. For example, there is a case in which a file 32 of a record of meeting is attached to a ticket 31 related to the meeting.

In a case of a group of research papers, it is possible to precisely estimate relevance of documents even if the estimation is made by excluding “index words” that tend to represent types of documents in advance and using only topics derived from “content words” that tend to represent content of researches. However, multiple types of documents are present if target documents are the tickets 31 and the files 32. Therefore, types of documents are also desired to be taken into consideration in order to precisely estimate relevance of the documents. If topics are extracted without excluding index words in order to take the types of the documents into consideration, it is determined that there is a strong relationship with “topics that are derived from content words”, which originally have no relationship with “topics that are derived from the index words”, in some cases.

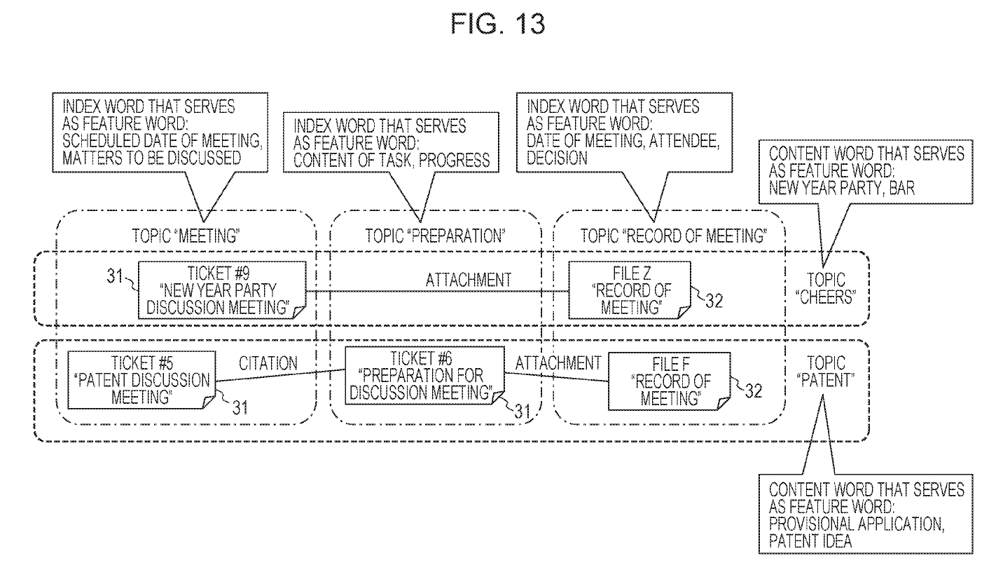

As illustrated in FIG. 13, it is assumed that each of a ticket #9 and a ticket #5 includes a topic “Meeting” that is derived from index words and that each of a file Z and a file F includes a topic “Record of meeting” that is derived from index words, for example. In addition, it is assumed that each of the ticket #9 and the file Z includes a topic “Cheers” that is derived from content words, and that each of the ticket #5 and the file F includes a topic “Patent” that is derived from content words.

In such a case, it is determined via the ticket #9 that there is a relationship between the topic “Meeting” that is derived from the index words and the topic “Cheers” that is derived from the content words. If a topic model in which the topic “Meeting” that is derived from the index words and the topic “Cheers” that is derived from the content words have a strong relationship is used, then files with no relationships may be specified in some cases. Specifically, the file Z including the topic “Cheers” that is derived from content words, such as “New year party” and “Bar”, with no relationship is specified when the ticket #5 including the topic “Meeting” that is derived from the index words are read, in some cases.

Thus, a weight of a relationship is adjusted to be small when types of topics are different in order to suppress an influence of the relationship between the topics of different types on estimation of relevance of the documents, based on the fact that there is no special relationship between index words and content words in many cases. In doing so, it is possible to suppress the disadvantage that it is estimated that all the documents have relevance to each other.

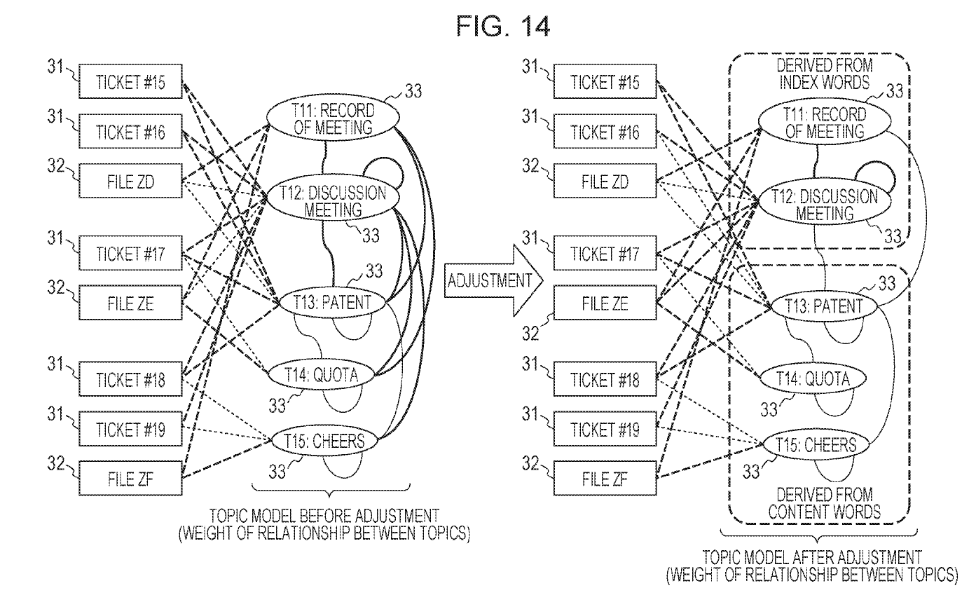

FIG. 14 conceptually illustrates a state in which weights of relationships are adjusted by the construction unit 13. In FIG. 14, mixing rates of topics 33 in the respective documents are represented by thicknesses of lines connecting between the documents and the topics 33, and the strength of relationships between the topics 33 is represented by thicknesses of lines connecting between topics 33. Before adjustment of the weights of the relationships, the topics 33 that are derived from index words and the topics 33 that are derived from content words have relationships of the same strength as that of relationships between topics 33 of the same type. After the adjustment, the strength of the relationships between the topics 33 of different types is suppressed.

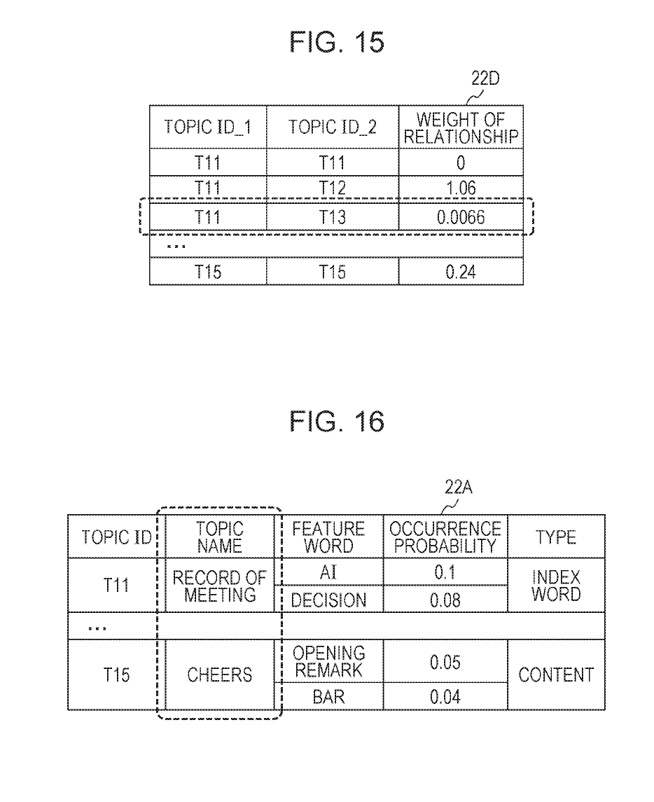

The construction unit 13 updates values of “Weight of relationship” in the topic-topic table 22D with the obtained weights of relationships after the adjustment as represented in the broken line part in FIG. 15.

The construction unit 13 provides the topic table 22A to a user (an administrator or an operator). The user also refers to “types” of topics and inputs a name, which is associable with feature words of each topic, as a topic name of the topic. If “Action item (AI)” and “Decision” are included in feature words, for example, “Record of meeting” is associable as a concept that is expressed by using these index words. Therefore, the user can input “Record of meeting” as a topic name. The construction unit 13 receives the input of the topic name and registers the received topic name in the topic table 22A as represented by the broken line part in FIG. 16. The registration of the topic name may not be performed.

In doing so, the topic model DB 22 that includes the topic table 22A, the ticket-topic table 22B, a file-topic table 22C, and a topic-topic table 22D is constructed.

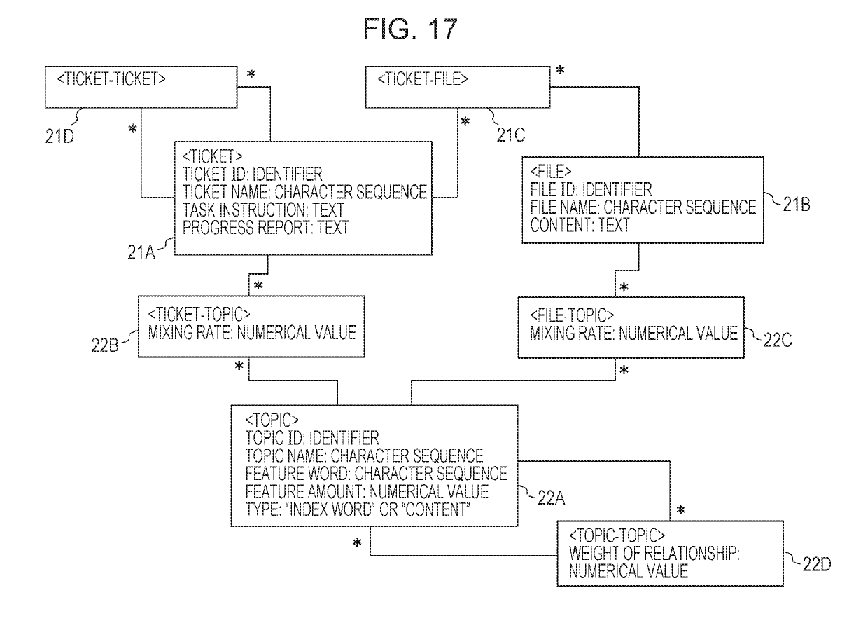

FIG. 17 illustrates relationships between the respective tables that are stored in the ticket and file DB 21 and the topic model DB 22. In FIG. 17, the respective tables are represented by the respective blocks, table names are represented in < >, and items included in the respective tables are represented below the table names. In addition, items that are associated with items in other tables are represented only on the side of the tables as sources of the association, which are connected by connecting lines. “*” represents that items that are associated with items in other tables can overlap on the side of the tables where “*” is represented.

The specification unit 14 calculates relevance that indicates a degree of possibility at which a specific ticket 31 has relevance with each of files 32 that are stored in the ticket and file DB 21 when the specific ticket 31 is read, specifies a file 32 with high relevance, and recommends the file 32 to the operator.

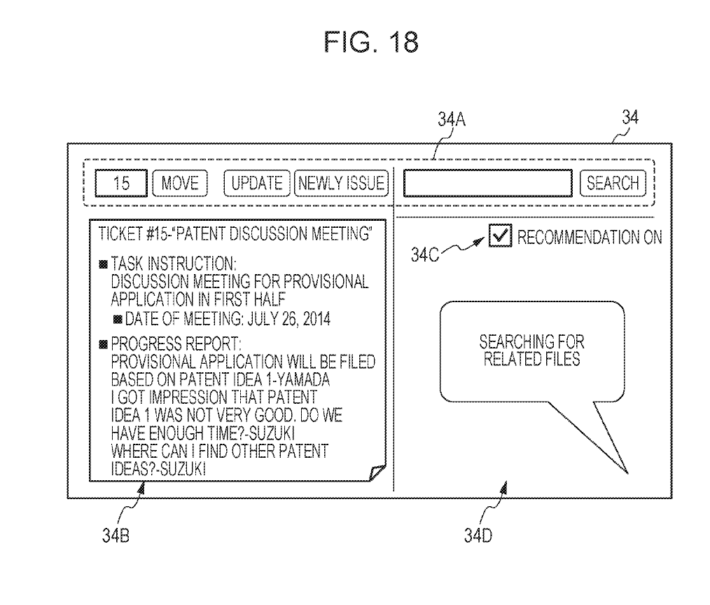

Specifically, the specification unit 14 displays an operation screen 34 as illustrated in FIG. 18, for example, on a display device (not illustrated) that is connected to the client terminal 102 for the administrator or the client terminal 103 for the operator. In the example illustrated in FIG. 18, the operation screen 34 includes buttons for instructing to move, update, newly issue, and search for the ticket 31, for example, an instruction tool 34A such as a text box, and a reading target ticket display region 34B in which the ticket 31 to be read is displayed. In addition, the operation screen 34 includes a check box 34C that is checked when the file 32 related to the ticket 31 to be read, which is being displayed in the reading target ticket display region 34B, is to be recommended and is unchecked when no recommendation is desired. The operation screen 34 includes a related file display region 34D in which the file 32 related to the ticket 31 to be read, which is being displayed in the reading target ticket display region 34B, is displayed. While the related file 32 is being searched for, a message that indicates that the relate file 32 is being searched for is displayed in the related file display region 34D as illustrated in FIG. 18.

The specification unit 14 receives a ticket ID of the ticket 31 to be read, which is input by a user operation, then obtains the target ticket 31 from the ticket table 21A by using the ticket ID as a key, and displays the target ticket 31 in the reading target ticket display region 34B on the operation screen 34. In addition, the specification unit 14 determines whether or not the check box 34C is checked. If the check box 34C is checked, relevance (t, f) between the ticket 31 (ticket t) to be read and each file 31 (file f) is calculated by the following Equation (4), for example.

$$Relevance ( t , f ) = {\sum }_{{T}_{t} , ∈ t} Mixing rate ( {T}_{t} ) {\sum }_{{T}_{f} ∈ f} Weight of relationship ( {T}_{t} , {T}_{f} ) \cdot Mixing rate ( {T}_{f} ) \qquad ( 4 )$$

Tₜ is a topic that is included in the ticket t, and a mixing rate (Tₜ) is a mixing rate of the topic Tₜ in the ticket t. T_{f} is a topic included in the file f, and a mixing rate (T_{f}) is a mixing rate of the topic T_{f} in the file f. The specification unit 14 obtains each topic Tₜ and the mixing rate (Tₜ) in the ticket t from the ticket-topic table 22B by using the ticket ID of the ticket 31 to be read as a key. In addition, the specification unit obtains each topic T_{f} and the mixing rate (T_{f}) in each file f from the file-topic table 22C. Furthermore, the specification unit 14 obtains a weight of a relationship (Tₜ, T_{f}) from the topic-topic table 22D for each combination between the topic Tₜ and the topic T_{f}. The weight of the relationship obtain at this timing is a weight of a relationship after the adjustment. Then, the specification unit 14 calculates the relevance (t, f) between the ticket t and each file f based on Equation (4) by using the obtained information.

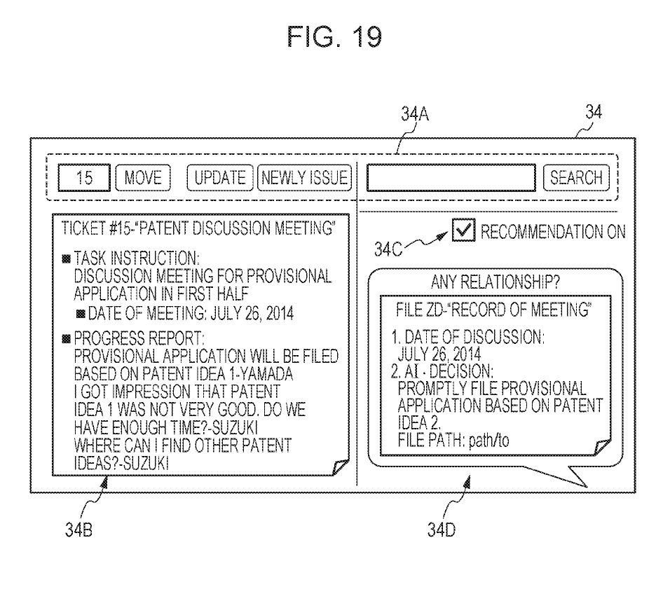

The specification unit 14 specifies a file f with the maximum relevance as the file 32 related to the ticket 31 to be read, which is being displayed in the reading target ticket display region 34B. Then, the specification unit 14 obtains the file 32 from the file table 21B by using a file ID of the specified file 32 as a key and displays the file 32 in the related file display region 34D on the operation screen 34. FIG. 19 illustrates an example of the operation screen 34 on which the related file 32 is being displayed.

The embodiment is not limited to the case in which the file 32 with the maximum relevance is recommended as the file 32 related to the ticket 31 to be read as illustrated in FIG. 19. Files 32 with relevance that is equal to or greater than a certain value or a certain number of files 32 with top relevance may be recommended. In such cases, the plurality of files 32 may be displayed in an overlapped manner or file names may be listed in the related file display region 34D.

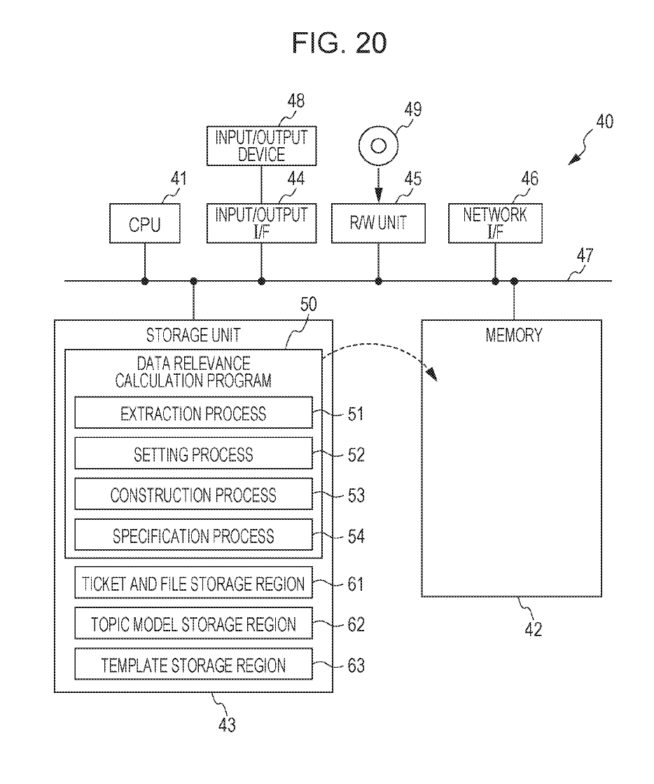

The data relevance calculation device 10 can be realized by a computer 40 illustrated in FIG. 20, for example. The computer 40 is provided with a CPU 41, a memory 42 as a temporary storage region, and a non-volatile storage unit 43. In addition, the computer 40 is provided with an input/output interface (I/F) 44 to which input/output devices 48 such as a display device and an input device are connected. Moreover, the computer 40 is provided with a reading/writing (R/W) unit 45 that controls reading data from a storage medium 49 and writing data in the storage medium 49 and a network I/F 46 that is connected to a network 15 such as the Internet. The CPU 41, the memory 42, the storage unit 43, the input/output I/F 44, the R/W unit 45, and the network I/F 46 are connected to each other via a bus 47.

The storage unit 43 can be realized by a hard disk drive (HDD), a solid state drive (SSD), a flash memory, or the like. The storage unit 43 as a storage medium stores a data relevance calculation program 50 for causing the computer 40 to function as the data relevance calculation device 10. In addition, the storage unit 43 includes a ticket and file storage region 61 in which information forming the ticket and file DB 21 is stored, a topic model storage region 62 in which information forming the topic model DB 22 is stored, and a template storage region 63 in which information forming the template DB 23 is stored.

The CPU 41 reads the data relevance calculation program 50 from the storage unit 43, develops the data relevance calculation program 50 in the memory 42, and sequentially executes processes included in the data relevance calculation program 50. In addition, the CPU 41 reads information from the ticket and file storage region 61 and develops the information as the ticket and file DB 21 in the memory 42. Moreover, the CPU 41 reads information from the topic model storage region 62 and develops the information as the topic model DB 22 in the memory 42. Furthermore, the CPU 41 reads information from the template storage region 63 and develops the information as the template DB 23 in the memory 42.

The data relevance calculation program 50 includes an extraction process 51, a setting process 52, a construction process 53, and a specification process 54. The CPU 41 operates as the extraction unit 11 illustrated in FIG. 4 by executing the extraction process 51. The CPU 41 operates as the setting unit 12 illustrated in FIG. 4 by executing the setting process 52. The CPU 41 operates as the construction unit 13 illustrated in FIG. 4 by executing the construction process 53. The CPU 41 operates as the specification unit 14 illustrated in FIG. 4 by executing the specification process 54. In doing so, the computer 40 that executes the data relevance calculation program 50 functions as the data relevance calculation device 10.

The data relevance calculation device 10 can also be realized by, for example, a semiconductor integrated circuit, more specifically, by an application specific integrated circuit (ASIC).

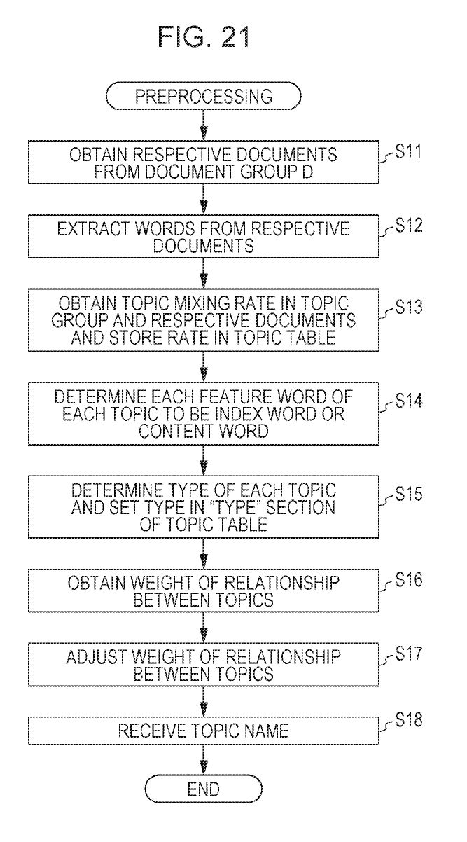

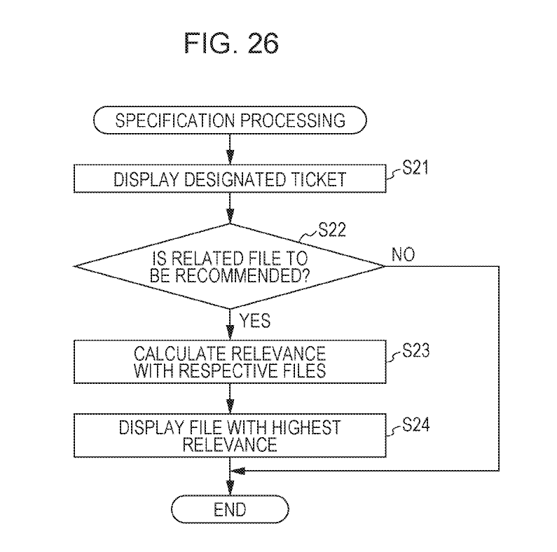

Next, a description will be given of operations of the data relevance calculation device 10 according to the embodiment. The data relevance calculation device 10 executes the preprocessing illustrated in FIG. 21 at a certain timing, such as once a day or once a week, or at a timing instructed by the administrator through the client terminal 102. If the ticket ID of the ticket 31 to be read is designated from the client terminal 102 for the administrator or the client terminal 103 for the operator, specification processing illustrated in FIG. 26 is executed. Hereinafter, a detailed description will be given of the respective processing.

First, a description will be given of the preprocessing illustrated in FIG. 21.

In Step S11, the extraction unit 11 obtains, as a document d_s, each of the tickets 31 and the files 32 that are included in the group of documents D stored in the ticket and file DB 21. Here, it is assumed that the ticket and file DB 21 stores the tickets 31 and the files 32 illustrated in FIGS. 5 and 6.

Next, the extraction unit 11 extracts words w_s_a from each document d_s by morphological analysis in Step S12. Here, it is assumed that the words w_s_a are extracted from each document d_s as illustrated in FIG. 7, for example.

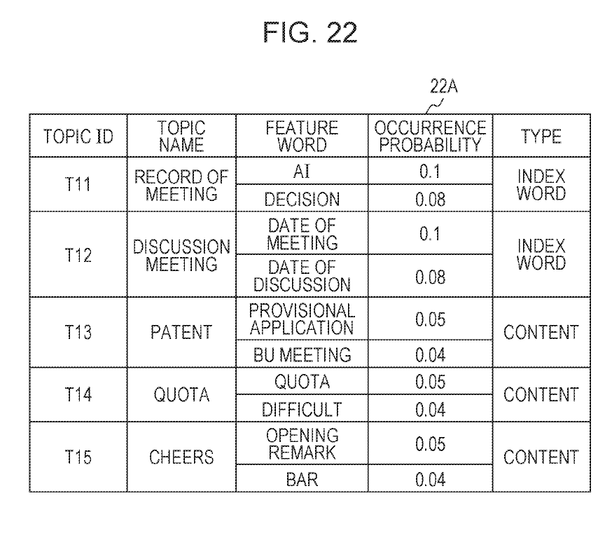

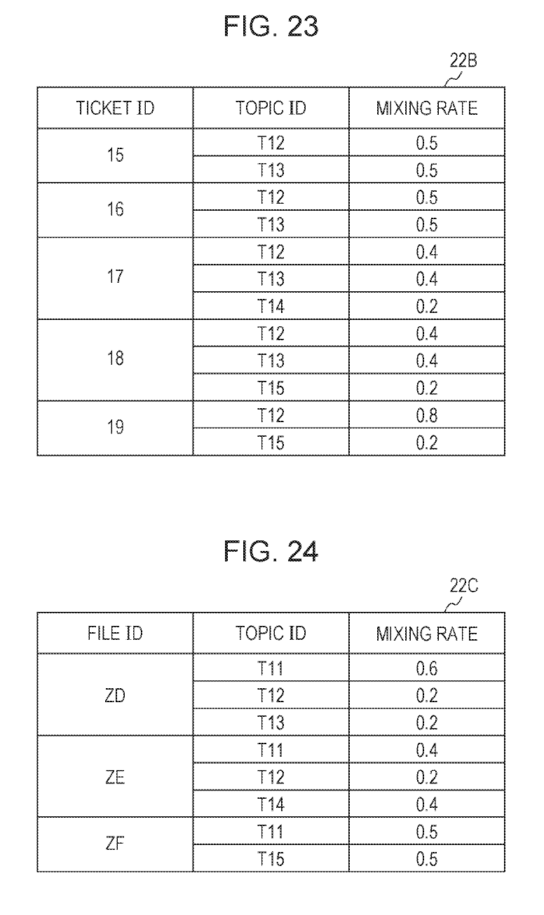

Next, the extraction unit 11 sets the number tn of topics (tn>0) and the number fn of top feature words (fn>0) in each topic as parameters of the LDA algorithm in Step S13. Here, it is assumed that tn=5 and fn=2 are set. Then, the extraction unit 11 obtains a group of topics TP and topic mixing rates MP in each document d_s based on the LDA algorithm by using the words w_s_a extracted from each document d_s and the set parameters tn and fn. The extraction unit 11 stores the obtained group of topics TP in the topic table 22A of the topic model DB 22, and stores the topic mixing rates MP in each document d_s in the ticket-topic table 22B or the file-topic table 22C. Here, it is assumed that storage in the topic table 22A illustrated in FIG. 22, the ticket-topic table 22B illustrated in FIG. 23, and the file-topic table 22C illustrated in FIG. 24 is performed. In this stage, the section of “Type” in the topic table 22A is blank.

Next, the setting unit 12 specifies index parts of each document by applying the document structure template 23A stored in the template DB 23 to each document, extracts words included in the specified index parts, and stores the word in the index word list 23B in Step S14. If each feature word in each topic that is stored in the topic table 22A coincides with any of the words that are stored in the index word list 23B, then the setting unit 12 determines the feature word as an “index word”. If the feature word does not coincide with any of the words that are stored in the index word list 23B, then the setting unit 12 determines the feature word as “content word”.

Next, the setting unit 12 determines which of index words and content words each topic is derived from, based on a result of determining which of an index word or a content word a feature word of each topic is, in Step S15. Then, the setting unit 12 sets “Index” in the section of “Type” in the topic table 22A for a topic that is determined to be derived from the index words and sets “Content” for a topic that is determined to be derived from the content words. Here, it is assumed that setting is made as illustrated in the sections of “Type” in the topic table 22A in FIG. 22.

Next, the construction unit 13 obtains a weight of relationship that represents the strength of a relationship between topics by Equations (1) and (2), for example, in Step S16. A description will be given of an example in which a weight of a relationship (T11, T13) between a topic Tₓ=topic ID=T11 (hereinafter, the topic with the topic ID=x will be described as a “topic x”) and a topic T_{y}=topic T13 is obtained. It is assumed that the ticket and file DB 21 illustrated in FIG. 6 and the respective tables illustrated in FIGS. 22 to 24 are used.

Referring to the ticket-topic table 22B in FIG. 23 and the file-topic table 22C in FIG. 24, objects oₙ that include the topic T11 are a file ZD, a file ZE, and a file ZF. Similarly, objects o₁₃ that include the topic T13 is a ticket #15, a ticket #16, a ticket #17, a ticket #18, and the file ZD. Further referring to the ticket-file table 21C and the ticket-ticket table 21D in FIG. 6, (o₁₃, o₁₁) that satisfies Rel (o₁₃, o₁₁)=1 is as follows.

(Ticket #16, File ZD)

(Ticket #17, File ZE)

(Ticket #18, File ZF)

Referring to the ticket-topic table 22B in FIG. 23 and the file-topic table 22C in FIG. 24, the mixing rate (oₙ, T11) and the mixing rate (o₁₃, T13) are as follow.

Mixing rate (File ZD, T₁₁)=0.6 Mixing rate (Ticket #16, T₁₃)=0.5

Mixing rate (File ZE, T₁₁)=0.4 Mixing rate (Ticket #17, T₁₃)=0.4

Mixing rate (File ZF, T₁₁)=0.5 Mixing rate (Ticket #18, T₁₃)=0.4

Therefore, based on Equation (2),

RT(T11,T13)=0.6×0.5+0.4×0.4+0.5×0.4=0.66.

Since RT (T13, T11) is also the same value, the weight of the relationship (T11, T13)=0.66 based on Equation (1). The construction unit 13 obtains weights of relationships between topics for all the combinations of the topics and stores the weights of the relationship in the topic-topic table 22D of the topic model DB 22.

Next, In Step S17, the construction unit 13 adjust the weight of the relationship (Tₓ, T_{y}) between the topic Tₓ and the topic T_{y}, which is stored in the topic-topic table 22D, based on Equation (3), for example, and obtains the weight of the relationship (Tx, Ty) after the adjustment. A description will be given of the example of the aforementioned weight of the relationship (T11, T13). Referring to the topic table 22A in FIG. 22, the type of the topic T11 is “Index”, the type of the topic T13 is “Content”, and these types are different from each other. Therefore, Same (T11, T13) in Equation (3) is ε (here, it is assumed that ε=0.01) and the weight of the relationship after the adjustment is obtained as follows.

$$\begin{matrix} \begin{matrix}Adjusted weight of \\ relationship ( T 11 , T 13 )\end{matrix} = Weight of relationship ( T 11 , T 13 ) \cdot \\ Same ( T 11 , T 13 ) \\ = 0.66 \times 0.01 = 0.0066\end{matrix}$$

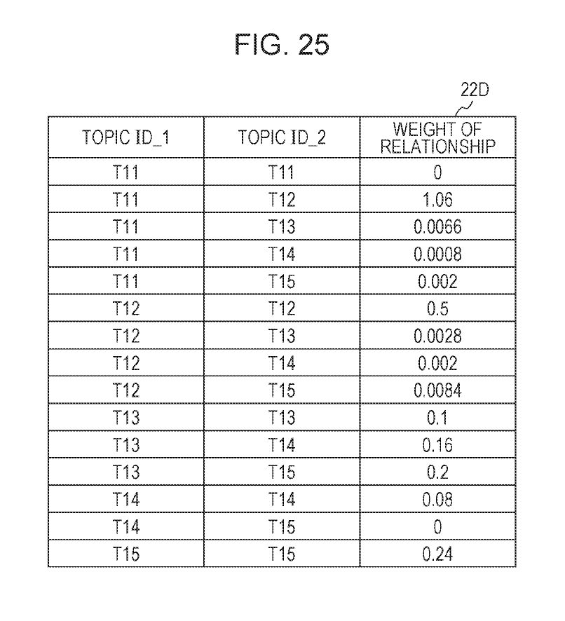

The construction unit 13 updates the values of “Weight of relationship” in the topic-topic table 22D with the weights of the relationships after the adjustment. Here, it is assumed that the topic-topic table 22D in which the weights of the relationships are adjusted has been brought into the state illustrated in FIG. 25.

Next, the construction unit 13 receives type names of the topics from the user, registers the type names in the topic table 22A, and completes the preprocessing in Step S18.

Next, a description will be given of the specification processing illustrated in FIG. 26.

In Step S21, the specification unit 14 displays the operation screen 34 as illustrated in FIG. 18, for example, on the display device (not illustrated) that is connected to the client terminal 102 for the administrator or the client terminal 103 for the operator. Then, the specification unit 14 obtains the ticket 31 corresponding to a designated ticket ID from the ticket table 21A and displays the ticket 31 in the reading target ticket display region 34B on the operation screen 34. Here, it is assumed that the ticket ID=#15 is designated. Therefore, the ticket #15 is displayed in the reading target ticket display region 34B.

Next, the specification unit 14 determines whether or to recommend a file 32 related to the ticket #15 by determining whether or not the check box 34C on the operation screen 34 is checked in Step S22. If the check box 34C is checked, it is determined that the related file 32 is to be recommended, and the processing proceeds to Step S23. If the check box 34C is not checked, the specification processing is then completed.

In Step S23, the specification unit 14 calculates relevance (t, f) by Equation (4). Here, the ticket t=the ticket #15. A description will be given of an example in which relevance (Ticket #15, File ZD) with the file f=the file ZD is calculated. The specification unit 14 obtains the topics T12 and T13 that are included in the ticket #15, the mixing rate (T12)=0.5, and the mixing rate (T13)=0.5 from the ticket-topic table 22B illustrated in FIG. 23 by using the designated ticket ID=#15 as a key. In addition, the specification unit 14 obtains the topics T11, T12, and T13 that are included in the file ZD, the mixing rate (T11)=0.6, the mixing rate (T12)=0.2, and the mixing rate (T13)=0.2 from the file-topic table 22C illustrated in FIG. 24.

Furthermore, the specification unit 14 obtains a weight of a relationship (Tₜ, T_{f}) as follows for each combination between the topic Tₜ ad the topic T_{f} from the topic-topic table 22D illustrated in FIG. 25.

Weight of relationship (T12, T11)=1.06

Weight of relationship (T12, T12)=0.5

Weight of relationship (T12, T13)=0.0028

Weight of relationship (T13, T11)=0.0066

Weight of relationship (T13, T12)=0.0028

Weight of relationship (T13, T13)=0.1

The specification unit 14 calculates relevance (Ticket #15, File ZD) as follows based on Equation (4) by using the obtained information.

$$\begin{matrix}Relevance ( Ticket \#15 , File ZD ) = 0.5 \times ( \begin{matrix}1.06 \times 0.6 + 0.5 \times \\ 0.2 + 0.0028 \times 0.2\end{matrix} ) + \\ 0.5 \times ( \begin{matrix}0.0066 \times 0.6 + \\ 0.0028 \times \\ 0.2 + 0.1 \times 0.2\end{matrix} ) \\ = 0.38054\end{matrix}$$

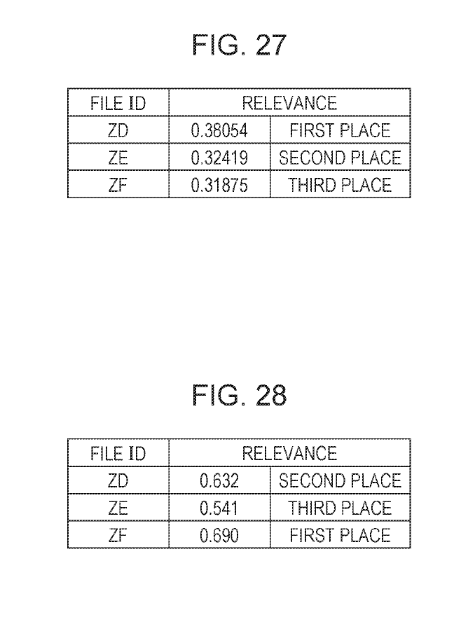

Next, the specification unit 14 specifies a file f whose relevance that is calculated in Step S23 is the maximum, in Step S24. It is assumed that the relevance with the file ZD is the maximum as illustrated in FIG. 27, for example. In such a case, the specification unit 14 obtains the file ZD from the file table 21B illustrated in FIG. 6 by using the file ID=ZD as a key, displays the file ZD in the related file display region 34D on the operation screen 34 as illustrated in FIG. 19, and completes the specification processing.

Here, FIG. 28 illustrates three files 32 with top relevance in a case of using the weights of the relationship of the topics before the adjustment based on the types of the topics. In FIG. 28, the file ZF has the maximum relevance. This is because an increase in relevance due to relationships between indexes and content, such as a relationship between the topics of “Record of meeting” and “Patent” and a relationship between the topics of “Discussion meeting” and “Patent”, exceeds a decrease in relevance due to difference in content of the topics of “Patent”, “Quota”, and “Cheers”. In such a case, the disadvantage that the file ZD that has no relevance with the ticket #15 being read in terms of content is recommended occurs.

As described above, such a point that a difference in relevance between the ticket 31 being read and each file 32 occurs before and after the adjustment of the weights of the relationships between the topics based on the types of the topics will be described by using another simple example and focusing on index words and content words in documents, in particular.

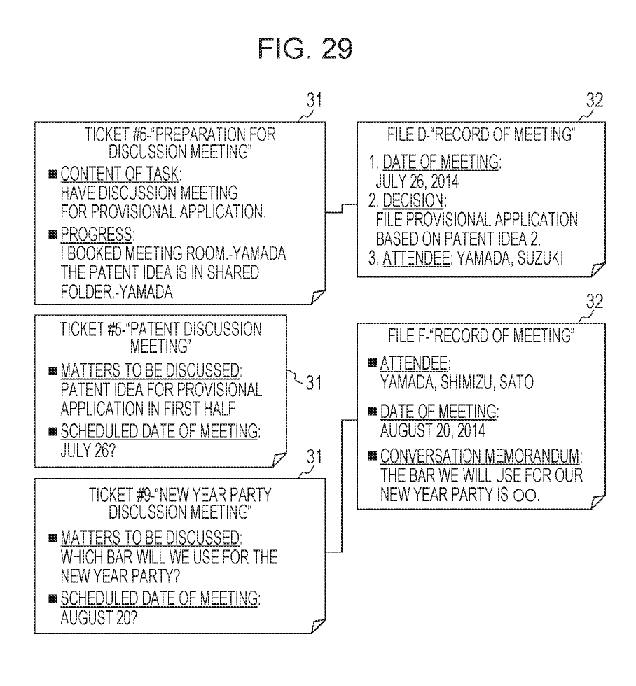

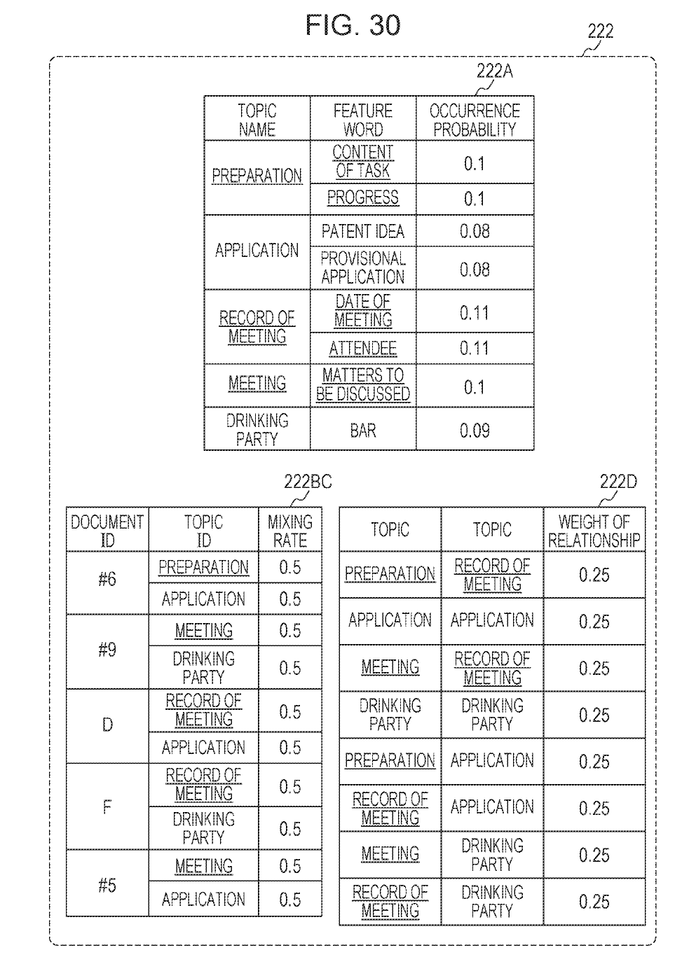

For example, a group of documents including the ticket #5, the ticket #6, the ticket #9, the file D, and the file F as illustrated in FIG. 29 will be considered. The ticket #6 is associated with the file D, and the ticket #9 is associated with the file F. In each document, underlined words are “index words”. Hereinafter, the index word and topics that are derived from the index words are similarly underlined in FIGS. 30 to 34.

It is assumed that a topic model DB 222 including a topic table 222A, a document-topic table 222BC, ad a topic-topic table 222D as illustrated in FIG. 30 is constructed from topics that are extracted from the group of documents illustrated in FIG. 29. Specifically, a weight of a relationship is calculated for each combination of topics included in the related ticket #6 and the file D and a combination of topics included in the ticket #9 and the file F without considering which of the index words and the content words the topics are derived from. In the example illustrated in FIG. 30, all the mixing rates of the topics included in the respective documents are set to “0.5” for easy explanation. Therefore, all the weights of the relationship between topics derived from the index words, between topics derived from the content words, and between a topic derived from the index words and a topic derived from the content words are “0.25”, and there is no difference in the strength of the relationships.

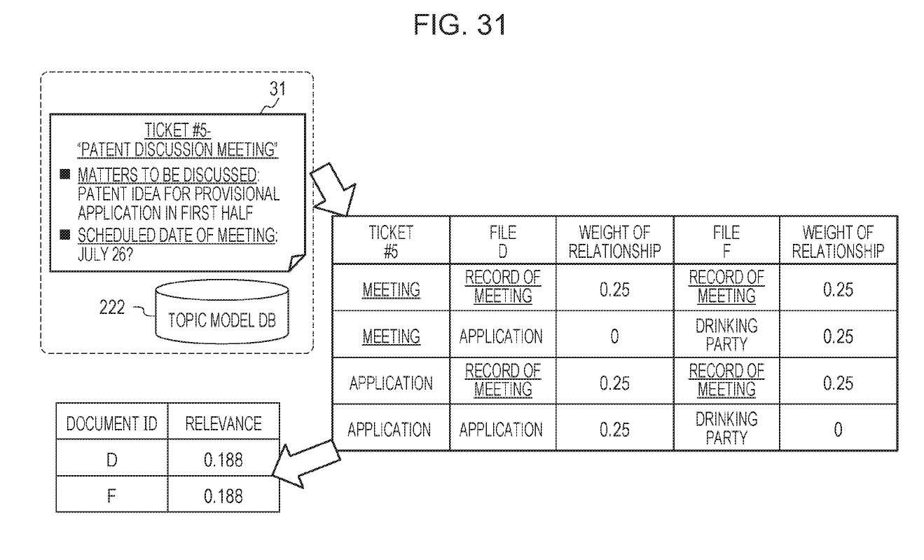

A case in which a file 32 related to the ticket #5 is specified as illustrated in FIG. 31, for example, by using the aforementioned topic model DB 222 will be considered. The ticket #5 includes topics of “Meeting” and “Application”, the file D includes topics of “Record of meeting” and “Application”, and the file F includes topics of “Record of meeting” and “Drinking party”. The ticket #5 is a ticket related to a patent discussion meeting, the file D is a record of the patent discussion meeting, and the file D is a record of a new year party discussion meeting. Therefore, the file D is originally to be recommended as the file relate to the ticket #5.

However, since the topic model DB 222 illustrated in FIG. 30 does not consider which of the index words and the content words the respective topics are derived from as described above, all the weights of the relationships between the topics are the same. Therefore, relevance between the ticket #5 and the file D and relevance between the ticket #5 and the file F are also the same. That is, the file D is not specified as the file to be recommended.

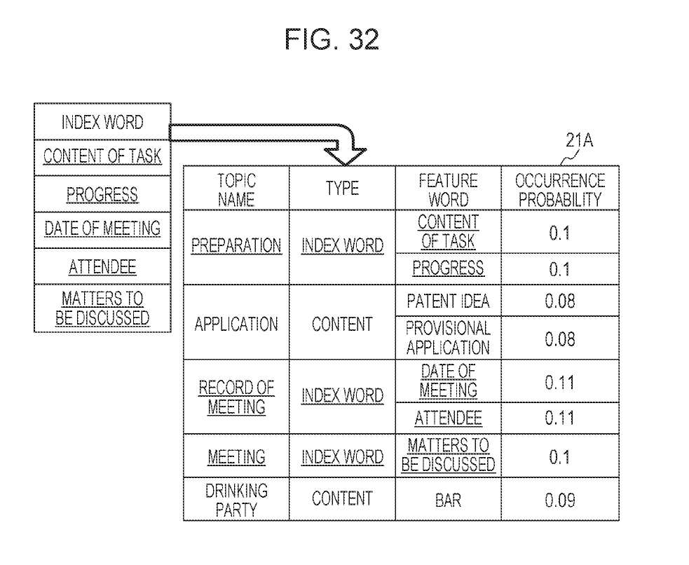

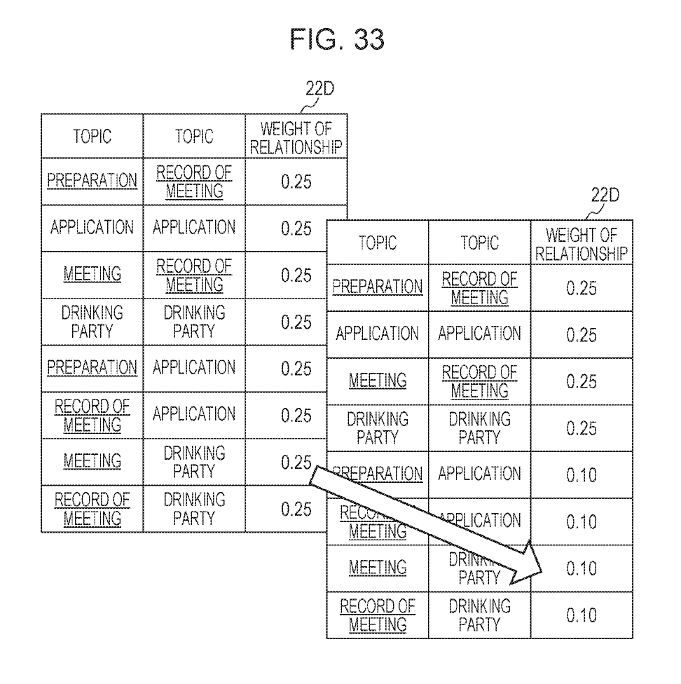

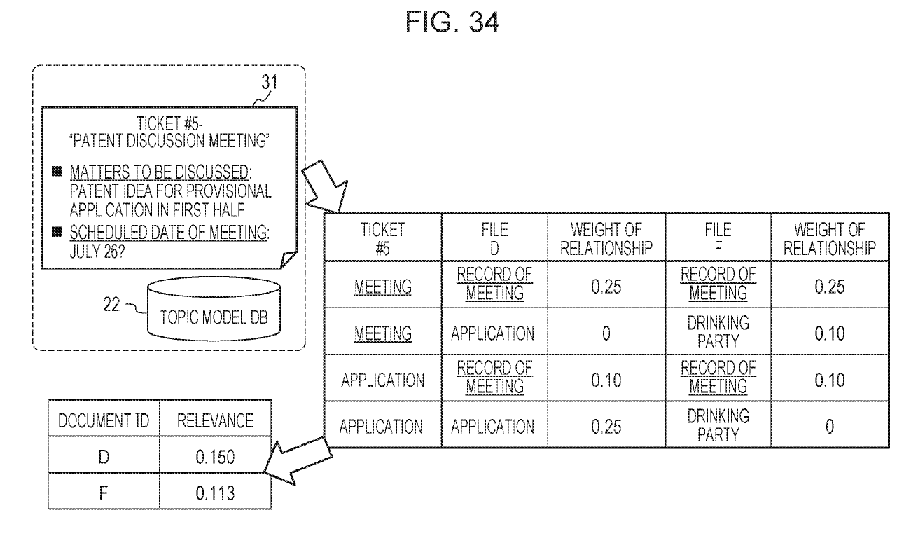

In contrast, types of the topics are set to either topics that are derived from the index words or topics that are derived from the content words based on rates of index words or content words in the feature words of the topics as illustrated in FIG. 32 according to the embodiment. Then, values of the weights of the relationships between the topics that are derived from the index words and the topics that are derived from the content words are adjusted to be small as illustrated in FIG. 33. By using the topic model DB 22 including the topic-topic table 22D that is adjusted as described above, it is possible to specify the file D as the file 32 to be recommended as illustrated in FIG. 34. This is because the influence of the relationships between the topics that are derived from the index words and the topics that are derived from the content words on the estimation of relevance of documents is suppressed by the adjustment of the weights of the relationships between the topics.

According to the data relevance calculation device of the embodiment, topics are extracted without excluding index words from a group of documents as described above. In addition, which of index words and content words each topic is derived from is set based on at least one of a degree at which each topic is characterized by the index words and a degree at which each topic is characterized by the content words. Then, the strength of relationships between topics that are derived from the index words and topics that are derived from the content words is set to be lower than the strength of relationships between the topics that are derived from the index words and the strength of relationships between the topics that are derived from the content words. In doing so, it is possible to suppress a disadvantage that relevance between documents is estimated due to an increase in the strength of the relationships between the topics that are derived from the index words and the topics that are derived from the content words, which originally have no special relationships. Therefore, it is possible to appropriately calculate relevance of the data (documents) that include index words with no commonality.

Since the relevance of the data can be calculated in consideration of combinations of types of data (documents) by extracting the topics without excluding the index words, it is possible to precisely calculate the relevance.

Although the description was given of the embodiment in which the topic model was constructed by sing information on relevance between the tickets and between the tickets and the files, information on relevance between the files may also be used. In addition, not only files related to the ticket being read but also other tickets related to the ticket being read and other files related to the flies may be specified.

Although a configuration in which the data relevance calculation program 50 as an example of the data relevance calculation program according to the technique disclosed herein was stored (installed) on the storage unit 43 in advance was described, the embodiment is not limited thereto. The data relevance calculation program according to the technique disclosed herein can be provided in a form of being recorded in a recording medium such as a CD-ROM, a DVD-ROM, or a USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory and computer-readable storage medium that stores a data relevance calculation program for causing a computer to execute processing comprising:
extracting a plurality of topics from a group of individual data items, each of which includes an index part and a content part, and a group of target data items, each of which includes an index part and a content part, and at least a part of which is related to any of the individual data items, based on words that are included in the group of the individual data items and the group of the target data items;
setting an attribute of each of the topics based on at least one of a degree at which each of the extracted topics is characterized by words that are included in the index part and a degree at which each of the extracted topics is characterized by words that are included in the content part; and
calculating relevance between any of the individual data items that are included in the group of the individual data items and each of the target data items that are included in the group of the target data items based on the strength of a relationship between a topic that is included in an individual data item and a topic that is included in a target data item related to the individual data item and on the attribute of each of the topics.

2. The storage medium that stores a data relevance calculation program according to claim 1,
wherein in a case where the attribute of the topic that is included in the individual data item differs from the attribute of the topic that is included in the target data item related to the individual data item in the calculating of the relevance, the strength of the relationship between the topics is set to be lower than the strength of the relationship between the topics in a case where the attributes of both the topics are the same.

3. The storage medium that stores a data relevance calculation program according to claim 1,
wherein as the attribute of each of the topics, an attribute indicating that the topic is characterized by the words included in the index part is set if the number of the words that are included in the index part is larger than the number of the words that are included in the content part among the plurality of words that characterize each topic, and an attribute indicating that the topic is characterized by the words included in the content part is set if the number of the words that are included in the content part is larger than the number of the words that are included in the index part.

4. The storage medium that stores a data relevance calculation program according to claim 1,
wherein the sum of probabilities at which the respective words that are included in the index part, from among a plurality of words that are extracted as words characterizing each topic, occur in the topic is a degree at which the topic is characterized by the words that are included in the index part, and the sum of probabilities at which the respective words that are included in the content part occur in the topic is a degree at which the topic is characterized by the words that are included in the content part.

5. The storage medium that stores a data relevance calculation program according to claim 1,
wherein each of the individual data items and the target data items is a document data item that is described in a natural language,
wherein the index part is a part in which words or word sequences in accordance with a type of content represented by the respective parts of the document data are described, and
wherein the content part is a part other than the index part in the document data.

6. A data relevance calculation device comprising:
an extraction unit configured to extract a plurality of topics from a group of individual data items, each of which includes an index part and a content part, and a group of target data items, each of which includes an index part and a content part, and at least a part of which is related to any of the individual data items, based on words that are included in the group of the individual data items and the group of the target data items;
a setting unit configured to set an attribute of each of the topics based on at least one of a degree at which each of the topics that are extracted by the extraction unit is characterized by words that are included in the index part and a degree at which each of the topics that are extracted by the extraction unit is characterized by words that are included in the content part; and
a calculation unit configured to calculate relevance between any of the individual data items that are included in the group of the individual data items and each of the target data items that are included in the group of the target data items based on the strength of a relationship between a topic that is included in an individual data item and a topic that is included in a target data item related to the individual data item and on the attribute of each of the topics set by the setting unit.

7. The data relevance calculation device according to claim 6,
wherein in a case where the attribute of the topic that is included in the individual data item differs from the attribute of the topic that is included in the target data item related to the individual data item, the calculation unit sets the strength of the relationship between the topics to be lower than the strength of the relationship between the topics in a case where the attributes of both the topics are the same.

8. The data relevance calculation device according to claim 6,
wherein the setting unit sets an attribute indicating that the topic is characterized by the words included in the index part if the number of the words that are included in the index part is larger than the number of the words that are included in the content part among the plurality of words that characterize each topic, and sets an attribute indicating that the topic is characterized by the words included in the content part if the number of the words that are included in the content part is larger than the number of the words that are included in the index part.

9. The data relevance calculation device according to claim 6,
wherein the setting unit regards a sum of probabilities at which the respective words that are included in the index part, from among a plurality of words that are extracted as words characterizing each topic, occur in the topic as a degree at which the topic is characterized by the words that are included in the index part, and regards a sum of probabilities at which the respective words that are included in the content part occur in the topic as a degree at which the topic is characterized by the words that are included in the content part.

10. The data relevance calculation device according to claim 6,
wherein each of the individual data items and the target data items is a document data item that is described in a natural language,
wherein the index part is a part in which words or word sequences in accordance with a type of content represented by the respective parts of the document data are described, and
wherein the content part is a part other than the index part in the document data.

11. A data relevance calculation method of causing a computer to execute processing comprising:
extracting a plurality of topics from a group of individual data items, each of which includes an index part and a content part, and a group of target data items, each of which includes an index part and a content part, and at least a part of which is related to any of the individual data items, based on words that are included in the group of the individual data items and the group of the target data items;
setting an attribute of each of the topics based on at least one of a degree at which each of the extracted topics is characterized by words that are included in the index part and a degree at which each of the extracted topics is characterized by words that are included in the content part; and
calculating relevance between any of the individual data items that are included in the group of the individual data items and each of the target data items that are included in the group of the target data items based on the strength of a relationship between a topic that is included in an individual data item and a topic that is included in a target data item related to the individual data item and on the attribute of each of the topics.

12. The data relevance calculation method according to claim 11,
wherein in a case where the attribute of the topic that is included in the individual data item differs from the attribute of the topic that is included in the target data item related to the individual data item, the strength of the relationship between the topics is set to be lower than the strength of the relationship between the topics in a case where the attributes of both the topics are the same.

13. The data relevance calculation method according to claim 11,
wherein as the attribute of each of the topics, an attribute indicating that the topic is characterized by the words included in the index part is set if the number of the words that are included in the index part is larger than the number of the words that are included in the content part among the plurality of words that characterize each topic, and an attribute indicating that the topic is characterized by the words included in the content part is set if the number of the words that are included in the content part is larger than the number of the words that are included in the index part.

14. The data relevance calculation method according to claim 11,
wherein a sum of probabilities at which the respective words that are included in the index part, from among a plurality of words that are extracted as words characterizing each topic, occur in the topic is regarded as a degree at which the topic is characterized by the words that are included in the index part, and a sum of probabilities at which the respective words that are included in the content part occur in the topic is regarded as a degree at which the topic is characterized by the words that are included in the content part.

15. The data relevance calculation method according to claim 11,
wherein each of the individual data items and the target data items is a document data item that is described in a natural language,
wherein the index part is a part in which words or word sequences in accordance with a type of content represented by the respective parts of the document data are described, and
wherein the content part is a part other than the index part in the document data.
